(19) United States
(12) Patent Application Publication
(10) Pub. No.: US 2026/0004125 A1
(43) Pub. Date: Jan. 1, 2026

(54) DYNAMIC SPARSITY PATTERNS FOR ATTENTION HEADS

(71) Applicant: Microsoft Technology Licensing, LLC, Redmond, WA (US)

(72) Inventors: Huiqiang JIANG, Shanghai (CN); Yucheng LI, Southampton (GB); Chengruidong ZHANG, Shanghai (CN); Qianhui WU, Beijing (CN); Xufang LUO, Shanghai (CN); Surin Lindsay AHN, Mountain View, CA (US); Zhenhua HAN, Shanghai (CN); Amir H. ABDI, Vancouver (CA); Dongsheng LI, Shanghai (CN); Chin-Yew LIN, Rolling Hills, CA (US); Yuqing YANG, Shanghai (CN); Lili QIU, Shanghai (CN)

(73) Assignee: Microsoft Technology Licensing, LLC, Redmond, WA (US)

(21) Appl. No.: 19/085,904

(22) Filed: Mar. 20, 2025

Related U.S. Application Data
(60) Provisional application No. 63/666,597, filed on Jul. 1, 2024.

(51) Int. Cl. G06N 3/08; G06N 3/045

(52) U.S. Cl. CPC G06N 3/08; G06N 3/045

(57) ABSTRACT

A computing system including processing circuitry configured to, during a calibration stage, perform a sparsity pattern search on a plurality of attention heads included in one or more transformer layers to select a respective sparsity pattern associated with each of the attention heads. During an inferencing stage, processing circuitry receives an inferencing input. The processing circuitry pre-fills a context based at least in part on the inferencing input. Pre-filling the context includes computing sparse attention scores at each of the attention heads. Computing the sparse attention scores includes masking each of the attention heads using the respective sparsity pattern selected for that attention head during the calibration stage. The processing circuitry computes an inferencing output by performing inferencing starting from the sparse attention scores. The processing circuitry outputs the inferencing output.

### CROSS REFERENCE TO RELATED APPLICATIONS

This application claims priority to U.S. Provisional Patent Application Ser. No. 63/666,597, filed Jul. 1, 2024, the entirety of which is hereby incorporated herein by reference for all purposes.

### BACKGROUND

The computational challenges of Large Language Model (LLM) inference remain a significant barrier to their widespread deployment, especially as prompt lengths continue to increase. In some instances, context pre-filling acts as a bottleneck during LLM inference. The pre-filling stage is a stage of LLM inference in which the attention scores of a transformer model are initialized prior to autoregressive token generation. Due to the quadratic complexity of the attention computation in transformer models, an 8B parameter LLM can take 30 minutes to process a prompt of 1 million tokens during the pre-filling stage when inferencing is performed on a single state-of-the-art graphics processing unit (GPU). Accordingly, existing LLM inferencing techniques may have difficulty generating accurate model outputs when long prompts are used.

### SUMMARY

According to one aspect of the present disclosure, a computing system is provided, including processing circuitry configured to, during a calibration stage, perform a sparsity pattern search on a plurality of attention heads included in one or more transformer layers of a transformer model to thereby select a respective sparsity pattern associated with each of the attention heads. During an inferencing stage, the processing circuitry is further configured to receive an inferencing input to the transformer model. The processing circuitry is further configured to pre-fill a context of the transformer model based at least in part on the inferencing input. Pre-filling the context includes computing a respective plurality of sparse attention scores at each of the attention heads. Computing the sparse attention scores includes masking each of the attention heads using the respective sparsity pattern selected for that attention head during the calibration stage. The processing circuitry is further configured to compute an inferencing output by performing inferencing at the transformer model starting from the sparse attention scores. The processing circuitry is further configured to output the inferencing output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system at which a transformer model is implemented, according to one example embodiment.

FIG. 2 schematically shows the computing system when processing circuitry is configured to perform a calibration stage and an inferencing stage at the transformer model, according to the example of FIG. 1.

FIGS. 3A-3C schematically show an A-shape pattern, a vertical-slash pattern, and a block-sparse pattern, respectively, according to the example of FIG. 2.

FIG. 4 shows plots of attention weight recall as a function of the number of FLOPs performed at a GPU kernel, according to the example of FIG. 2.

FIG. 5 schematically shows the computing system when the calibration stage is performed for a plurality of attention heads, according to the example of FIG. 2.

FIG. 6 schematically shows the computing system when masks associated with the attention heads are computed during the inferencing stage, according to the example of FIG. 2.

FIGS. 7A-7B show respective plots of log perplexity as a function of context window size for MInference and a plurality of baseline techniques, according to the example of FIG. 2.

FIG. 8A shows a plot of pre-filling latency as a function of context window size for MInference and FlashAttention-2, according to the example of FIG. 2.

FIG. 8B shows a plot of respective pre-filling latencies for the different sparsity patterns, compared to pre-filling latencies of FlashAttention-2 and InfLLM, according to the example of FIG. 2.

FIGS. 9A-9B show respective plots of the attention head sparsity patterns selected during the calibration stage for different layers of the transformer model, according to the example of FIG. 2.

FIG. 10 shows a plot of the sparsity of the attention matrices computed at a GPU kernel with the three different sparsity patterns, according to the example of FIG. 2.

FIG. 11A shows a flowchart of a method for use with a computing system to pre-fill and process a transformer model context, according to the example of FIG. 1.

FIG. 11B shows additional steps of the method of FIG. 11A that may be performed during an inferencing stage.

FIG. 11C shows additional steps of the method of FIG. 11A that may be performed during a calibration stage.

FIG. 12 shows a schematic view of an example computing environment in which the computing system of FIG. 1 may be instantiated.

### DETAILED DESCRIPTION

Existing methods for speeding up prefilling often fail to maintain acceptable accuracy or efficiency when applied to long-context LLMs. To address this gap, a technique referred to as “MInference” is described herein. MInference is a sparse attention score computation technique that accelerates pre-filling of transformer context windows during long-sequence processing. Using this technique, an attention matrix is computed as a sparse matrix, which is a matrix in which a large proportion of the matrix elements are equal to zero. Attention matrices computed at transformer models tend to follow recurring structural patterns regarding the locations of their approximately zero-valued matrix elements. Three types of patterns in long-context attention matrices are identified—the A-shape, Vertical-Slash, and Block-Sparse—that can be leveraged for efficient sparse computation on GPUs. During inference, the highest-efficiency pattern for each attention head is determined, and sparse indices based on the assigned pattern are constructed. With the identified sparsity patterns and the sparse indices, efficient sparse attention computations are performed via optimized GPU kernels. These sparse attention computations significantly reduce the latency in the pre-filling stage of long-context LLMs.

MInference can be directly applied to existing LLMs without any modifications to the pre-training setup or additional fine-tuning. By evaluating on a wide range of downstream tasks, including InfiniteBench, RULER, PG-19, and Needle In A Haystack, and models including LLaMA-3-8B and Yi-9B-200K, the experiments discussed below demonstrate that MInference effectively reduces inference latency by up to 10× for pre-filling on an A100 GPU, while also maintaining accuracy.

LLMs have entered the era of long-context processing, with some of them supporting context windows ranging from 128K to 4M tokens. These extended context windows enable LLMs to unlock a multitude of complex real-world applications, such as repository-level code modeling, long-document question-answering, extreme-label in-context learning, and long-horizon agent tasks.

However, due to the quadratic complexity of attention, it can take several minutes for the model to process the input prompt (i.e., the pre-filling stage) and then start to produce the first token. This delay can hinder the wide application of long-context LLMs. When executing LLaMA-3-8B on a single A100 GPU, for example, a user has to wait 6 minutes for the model to finish the pre-filling stage given a prompt of 300K tokens. This number increases to 30 minutes for a prompt of 1M tokens. The overhead of self-attention computation exceeds 90% of the total pre-filling latency, which makes it the primary bottleneck in long-context processing at LLMs.

Previous research has shown that the attention matrices are highly sparse, which has led to the development of fixed sparse attention methods such as Longformer and BigBird. However, prior studies have also noted that attention distributions vary significantly across different inputs. This dynamism prevents prior sparse methods from being used directly on long-context LLMs without expensive training or fine-tuning. But if the dynamic sparse attention patterns could be efficiently predicted online, the pre-filling latency of long-context LLMs could be significantly reduced by computing only the highest-relevance portions of the attention weights.

In order to address the above difficulties with long-context processing, a technique referred to as MInference is introduced herein. MInference uses dynamic sparse attention to reduce the number of floating-point operations (FLOPs) used in attention computation during the pre-filling stage of long-context LLM inference. This technique may reduce the number of FLOPs used in pre-filling by 95%. Unlike existing dynamic sparse attention methods that introduce large computational overhead to estimate attention patterns with low-rank hidden dimensions, MInference allows long-context pre-filling to be performed with minimal overhead.

Three general patterns of sparse attention in long-context LLMs are identified herein: an A-shape pattern, a vertical-slash pattern, and a block-sparse pattern. Based on these findings, a kernel-aware search method is introduced to assign the most efficient attention pattern to each attention head. Instead of fixed attention masks in prior approaches, an efficient online approximation is performed to build a sparse mask for each head according to the assigned sparse attention pattern and the specific inputs of that attention head.

In one example, to build a dynamic sparse mask for a specific prompt on one vertical-slash head, a partial of attention weight including the last last_q query and key vectors (i.e. Q_{[-last_q:]} and K) is used to estimate the most relevant indices of the vertical and slash lines globally on the attention matrix. In another example, mean pooling is performed on both the query and key vectors of a block-sparse attention head in blocks of 64×64 matrix elements each. Block-level attention weights are then computed to determine the most relevant blocks and thereby obtain a block-sparse dynamic mask.

Extensive experiments were conducted across different LLMs, including LLaMA-3-8B-1M, GLM-4-9B-1, and Yi-9B-1M, on various long-context benchmarks with context length over 1M tokens, such as InfiniteBench, RULER, Needle In A Haystack, and PG-19. Experimental results demonstrate that MInference speeds up the pre-filling stage by up to 10× for processing 1M-token contexts with LLaMA-3-8B on a single A100, reducing the inference latency from 30 minutes to 3 minutes per prompt, while maintaining comparable accuracy. Surprisingly, MInference achieved higher accuracy than the dense baseline in some experiments.

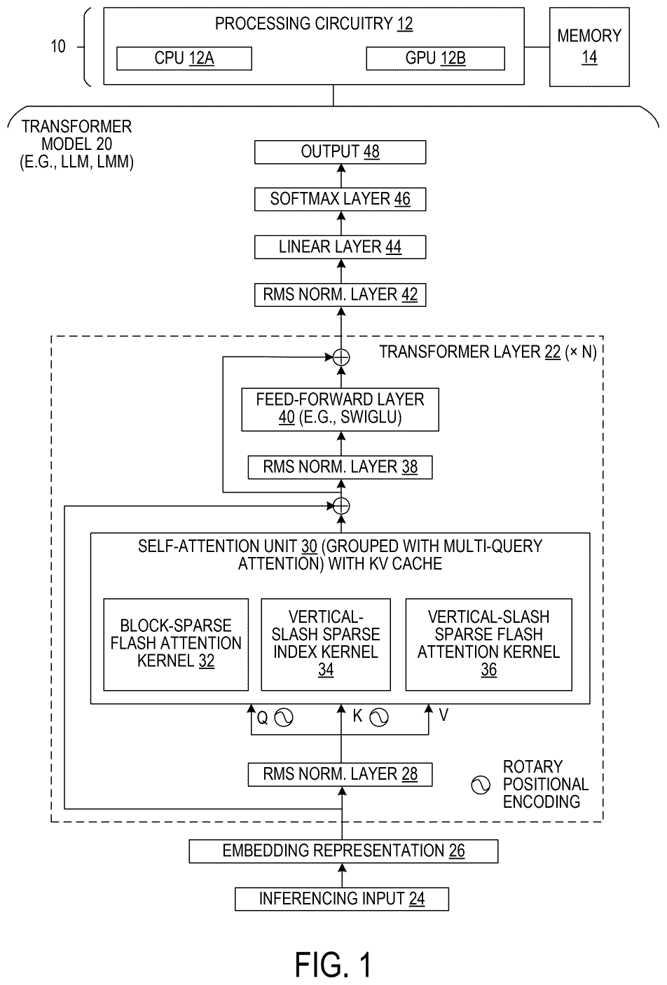

FIG. 1 schematically shows an example computing system 10 at which a transformer model 20 is implemented. The computing system 10 includes processing circuitry 12, which includes a central processing unit (CPU) 12A and a graphics processing unit (GPU 12B). Other types of hardware accelerators such as a tensor processing unit may additionally or alternatively be included in the processing circuitry 12. The computing system 10 further includes memory 14, which stores software instructions for implementing the systems and methods described herein.

The transformer model 20 executed at the processing circuitry 12 in the example of FIG. 1 may be a large language model (LLM) or a large multimodal model (LMM), examples of which include LLaMA, GPT-3.5, GPT-4o, etc. The architecture of a LLaMA model is depicted at inference time in the example of FIG. 1.

During inference, the processing circuitry is configured to receive an inferencing input 24 at the transformer model 20. The processing circuitry 12 is configured to tokenize this inferencing input 24 and convert the inferencing input 24 into an embedding representation 26. At a root mean squared (RMS) normalization layer 28, the processing circuitry 12 is further configured to compute an RMS norm of the embedding representation 26.

The processing circuitry 12 is further configured to pass the RMS norm, a query vector Q, a key vector K, and a value vector V to a self-attention unit 30. The self-attention unit 30 shown in the example of FIG. 1 has a KV cache that is configured to store previously computed products of the key vectors K and value vectors V. At the self-attention unit 30, the processing circuitry 12 is configured to compute respective self-attention scores for each of the tokens included in the inferencing input 24. Rotary positional encoding is applied to the query vectors Q and the key vectors K. The self-attention unit 30 shown in the example of FIG. 1 includes a block-sparse FlashAttention kernel 32, a vertical-slash sparse index kernel 34, and a vertical-slash sparse FlashAttention kernel 36, which are discussed in further detail below.

After computing the self-attention scores of the tokens, the processing circuitry 12 is further configured to add those self-attention scores to the embedding sequence computed thus far. The processing circuitry 12 is further configured to pass the sum to an RMS normalization layer 38 that computes another RMS norm. The processing circuitry 12 is further configured to pass that RMS norm to a feed-forward layer 40, which may, for example, be a SwiGLU feed-forward layer. The output of the feed-forward layer 40 is then added to the sum of the self-attention scores and the embedding sequence.

The transformer layers 22 included in the transformer model 20 can be stacked in series in N blocks. The output of the final transformer layer 22 is passed through an RMS normalization layer 42 to compute another RMS norm. The processing circuitry 12 is further configured to pass the RMS norm to a linear layer 44 and pass the output of the linear layer 44 through a SoftMax layer 46 to compute a probability distribution of the most likely next tokens in the input sequence. The processing circuitry 12 is further configured to compute an output 48 of the transformer model 20 by sampling output tokens from this probability distribution.

The sparsity of attention weights in pre-trained LLMs, especially in long-context scenarios, has been well-documented. In one example, for an attention matrix of size 128K×128K, retaining only the top 4K columns retains 96.8% of the total attention. Thus, each token attends to a small number of other tokens despite the length of the sequence processed at the LLM.

However, although LLMs exhibit attention matrix sparsity across different inputs, the exact distributions of sparse patterns are highly dynamic. That is to say, although a token in a specific position only attends to a small number of tokens in self-attention, the exact tokens attended to vary significantly across different prompts. For example, if the top 4K columns from the previous example are applied to another prompt of 128K length, the recall of attention drops significantly to 83.7%.

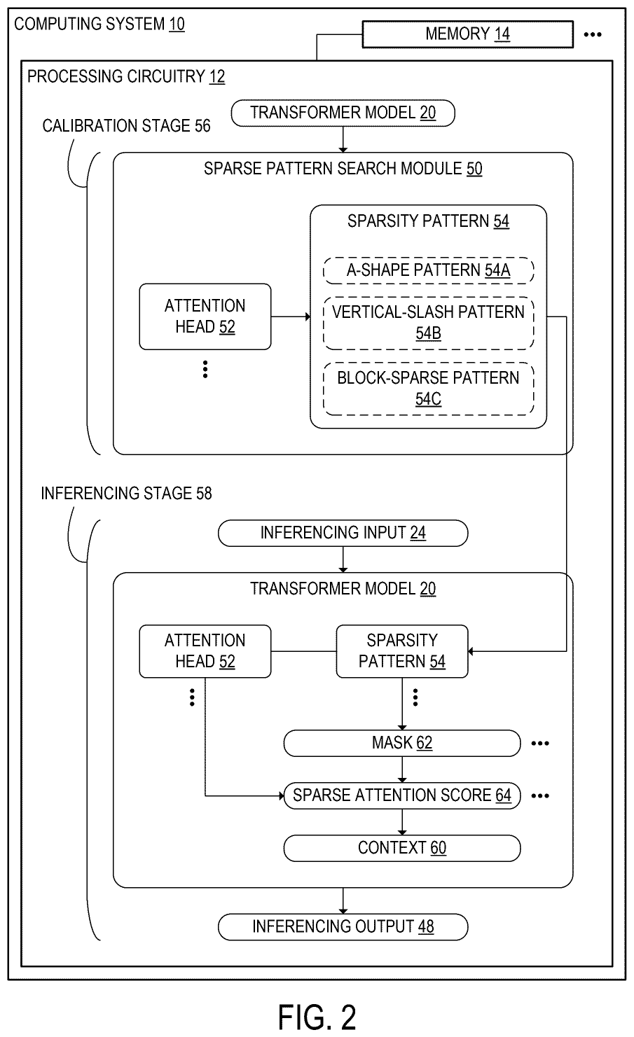

FIG. 2 schematically shows the computing system 10 when the processing circuitry 12 is configured to perform a calibration stage 56 and an inferencing stage 58 at the transformer model 20. The calibration stage 56 is performed in order to identify sparsity patterns 54 exhibited by the attention scores computed at the attention heads 52. During the calibration stage 56, the processing circuitry 12 is configured to execute a sparsity pattern search module 50 at which the processing circuitry 12 performs a sparsity pattern search on a plurality of attention heads 52 included in the one or more transformer layers 22 of the transformer model 20. By performing the sparsity pattern search, the processing circuitry 12 is configured to select a respective sparsity pattern 54 associated with each of the attention heads 52.

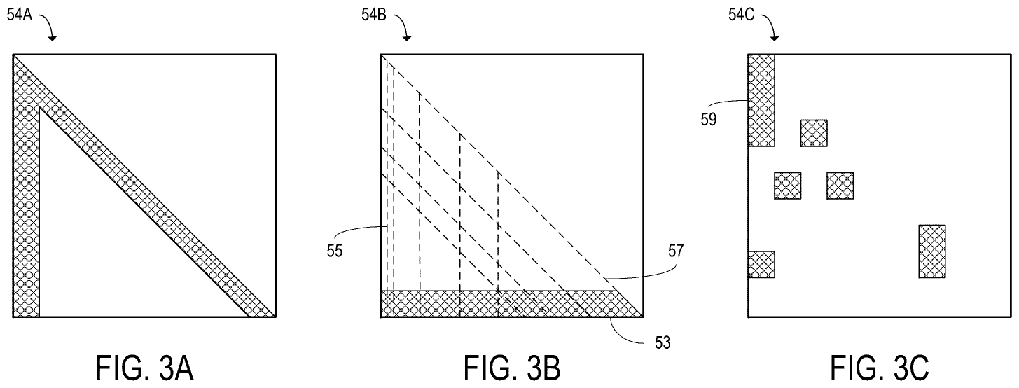

Although the sparsity distributions of attention matrices are dynamic, the sparsity distributions exhibit certain patterns such as spatial clustering in two-dimensional space. Through analysis of long-context prompts of various lengths and tasks, such sparsity patterns 54 have been categorized into A-shape patterns 54A, vertical-slash patterns 54B, and block-sparse patterns 54C. These patterns are schematically shown in FIGS. 3A-3C.

FIG. 3A shows an example A-shape pattern 54A. The attention weights of an attention head 52 with an A-shape pattern 54A are concentrated on initial tokens and local windows and therefore exhibit relatively higher stability than the attention weights of attention heads 52 with the other sparsity patterns.

FIG. 3B shows an example vertical-slash pattern 54B. In the vertical-slash pattern 54B, attention weights are concentrated on specific tokens (vertical lines 55) and tokens at fixed intervals (slash lines 57). The positions of vertical lines 55 and slash lines 57 in this pattern dynamically change with the contents of the prompt. Thus, the vertical lines 55 and slash lines 57 are difficult to encompass with local windows or A-shapes.

In the example of FIG. 3B, the processing circuitry 12 is further configured to compute a lower quadrilateral region 53 that includes each row of the attention weight matrix located below a predetermined row threshold. Attention scores within this lower quadrilateral region 53 may be approximated to compute a partial attention matrix when computing dynamic sparse indices for the vertical-slash pattern 54B and the block-sparse pattern 54C, as discussed in further detail below.

FIG. 3C shows an example block-sparse pattern 54C that includes a plurality of blocks 59. The block-sparse pattern 54C is more dynamic than the A-shape pattern 54A or the vertical-slash pattern 54B, exhibiting a more dispersed distribution. Despite its dynamism, the attention weights maintain some characteristics of spatial clustering. These clusters form the blocks 59 included in the block-sparse pattern 54C.

In one experiment, performed with LLaMA-3-8B-Instruct-262K, distances between non-zero attention weights and their top-k nearest non-zero neighbors within a 128K prompt were measured. The results of this experiment indicate that across layers and heads, the distances between nearest non-zero attention weights are typically concentrated around 5, suggesting a strong spatial clustering of the attention weights.

Table 1, shown below, details the characteristics of, and differences between, the three sparsity patterns. In addition, Table 1 compares the sparsity patterns to top-K column selection as a sparsification technique.

| Pattern | A-shape | Vertical-slash | Block-sparse | Top-K |
|---|---|---|---|---|
| Spatial | Static | Dynamic | Dynamic | Dynamic |
| distribution | structured | structured | structured | fine- |
| | | | | grained |
| Latency on | Low | Medium | Low | High |
| GPU | | | | |
| Time to build | Zero | Small | Small | High |
| the index | | | | |

Each attention head 52 is consistent across different inputs as to whether that attention head 52 exhibits the A-shape pattern 54A, the vertical-slash pattern 54B, or the block-sparse pattern 54C. However, for attention heads 52 that exhibit the vertical-slash pattern 54B or the block-sparse pattern 54C, the locations of the lines or blocks vary across different inputs. The calibration phase 56 is accordingly performed in order to determine, for each attention head 52, which of the three sparsity patterns 54 the attention head 52 follows. For each attention head 52, as discussed in further detail below, the processing circuitry 12 is further configured to compute a respective mask 62 that has the identified sparsity pattern 54 during the inferencing stage 58.

Returning to the example of FIG. 2, the processing circuitry 12 is further configured to receive an inferencing input 24 to the transformer model 20 during the inferencing stage 58. Based at least in part on the inferencing input 24, the processing circuitry 12 is further configured to pre-fill a context 60 of the transformer model 20. Pre-filling the context 60 includes computing a respective plurality of sparse attention scores 64 at each of the attention heads 52. These sparse attention scores 64 are the nonzero elements of a sparse attention matrix. In addition, computing the sparse attention scores 64 includes masking each of the attention heads 52 using the respective sparsity pattern 54 selected for that attention head 52 during the calibration stage 56. The processing circuitry 12 is configured to compute a respective mask 62 associated with each of the attention heads 52 using the corresponding sparsity pattern 54, as discussed in further detail below.

Subsequently to pre-filling the context 60, the processing circuitry 12 is further configured to compute an inferencing output 48 by performing inferencing at the transformer model 20 starting from the sparse attention scores 64. Thus, the processing circuitry 12 is configured to perform autoregressive generation of the inferencing output 48 starting from the sparse attention scores 64 initialized during pre-filling.

The processing circuitry 12 is further configured to output the inferencing output 48. In some examples, the inferencing output 48 is output to a user interface such as a graphical user interface (GUI) or an audio interface for presentation to the user. Additionally or alternatively, the inferencing output 48 may be output to some other computing process or storage location. For example, the inferencing output 48 may be output to a scratchpad of the transformer model 20.

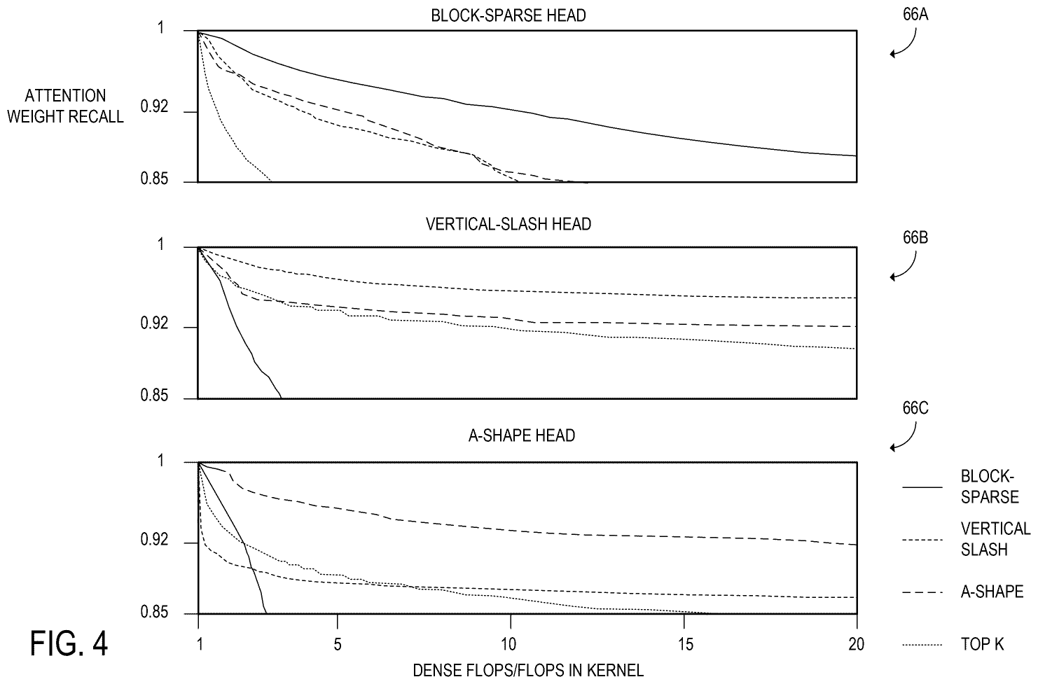

FIG. 4 shows plots 66A, 66B, and 66C of attention weight recall as a function of the number of FLOPs performed at a GPU kernel of an A100 GPU. These plots show the attention weight recall at respective attention heads 52 when a block-sparse mask, a vertical-slash mask, and an A-shape mask are used during the inferencing stage 58. In addition, the plots show the attention weight recall using a top K mask as a baseline. In the plot 66A, the attention head is one that was identified during the calibration stage 56 as having the block-sparse pattern 54C. In the plot 66B, the attention head is one that was identified during the calibration stage 56 as having the vertical-slash pattern 54B. In the plot 66C, the attention head is one that was identified during the calibration stage 56 as having the A-shape pattern 54A. As shown in each of the displayed plots, using the sparsity pattern 54 selected for the attention head 52 during the calibration stage 56 results in higher attention recall compared to the other sparsity patterns and compared to the top K baseline. This increase in attention weight recall becomes more pronounced as the number of FLOPs performed at the GPU kernel increases.

When performing pre-filling at the transformer model 20 with sparse attention, the attention matrix may be formulated as follows:

$$A ( M ) = SoftMax ( \frac{1}{\sqrt{d}} Q {K}^{T} - c ( 1 - M ) )$$

In the above equation, M_{i,j}∈{0,1} is the value of the sparse mask M for a matrix element i,j of the attention matrix. In addition, c is a large constant such as 1e5 that is used to set masked-out attention weights for which M_{i,j}=0 to values approximately equal to zero after the SoftMax, i.e., A_{i,j}≈0.

The goal of dynamic sparse attention is to achieve an inferencing speedup with minimal overhead while retaining the information encoded in the attention weights. Formally, this goal can be represented with the following minimization objectives:

$$min \vert A ( M ) - {A}_{d e n s e} \vert$$

$$min ( {t}_{sparse} ( M ) + {t}_{overhead} ( M ) )$$

In the above expressions, A_{dense} is a dense attention matrix, and tₛₚₐᵣₛₑ and t_{overhead} represent the time spent on dynamic sparse attention computation and estimation of the approximate dynamic sparse pattern, respectively.

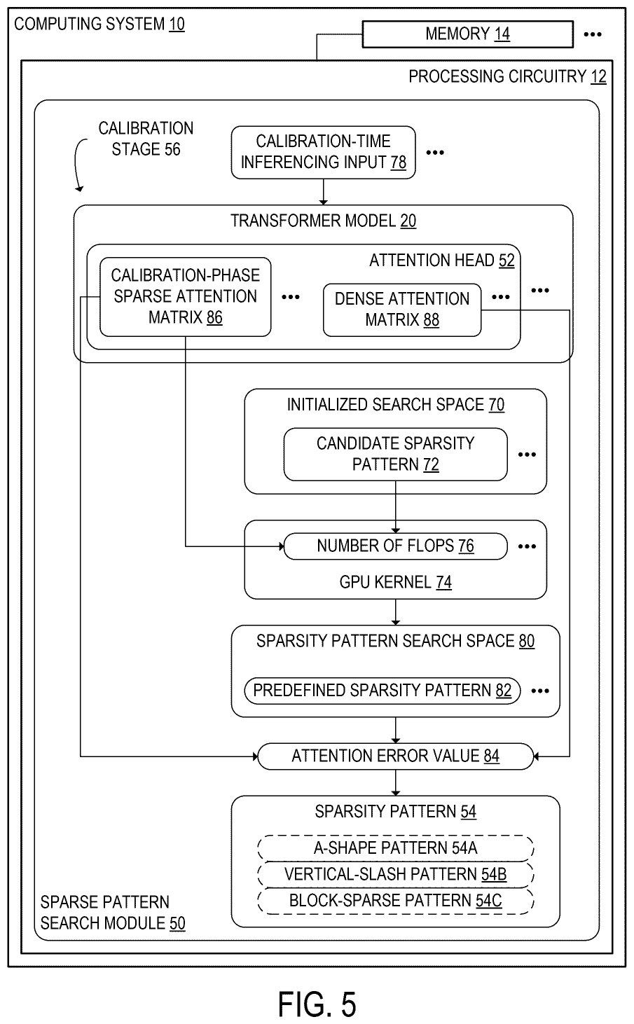

FIG. 5 schematically shows the computing system 10 in additional detail when the calibration stage 56 is performed for the plurality of attention heads 52. During the calibration stage 56, the processing circuitry 12 is configured to approximately minimize the minimization objectives discussed above. At the sparse pattern search module 50, the processing circuitry 12 is configured to compute a sparsity pattern search space 80 including a plurality of predefined sparsity patterns 82. The processing circuitry 12 is further configured to select the sparsity pattern 54 associated with that attention head 52 from among the plurality of predefined sparsity patterns 82 in the sparsity pattern search space 80. In some examples, the predefined sparsity patterns 82 may be the A-shape pattern 54A, the vertical-slash pattern 54B, and the block-sparse pattern 54C. In other examples, multiple variants of the vertical-slash pattern 54B and/or the block-sparse pattern 54C may be included in the sparsity pattern search space 80. In still other examples, the sparsity pattern search space 80 may omit the A-shape pattern 54A, the vertical-slash pattern 54B, or the block-sparse pattern 54C.

In some examples, for each attention head 52, the processing circuitry 12 may be configured to select the sparsity pattern 54 from among the plurality of predefined sparsity patterns 82 at least in part by computing respective attention error values 84 for the predefined sparsity patterns 82 relative to a dense attention matrix 88 computed for that attention head 52. The dense attention matrices 88 are computed at the attention heads 52 using respective calibration-time inferencing inputs 78 to the transformer model 20. In addition, computing the attention error value 84 further includes computing a respective calibration-phase sparse attention matrix 86 using each of the predefined sparsity patterns 82. The attention error value 84 therefore indicates the amount of error incurred in the attention weights by sparsifying the attention weights with the predefined sparsity pattern 82. The processing circuitry 12 is further configured to select the predefined sparsity pattern 82 that has the lowest attention error value 84 as the sparsity pattern 54.

In some examples, for each of the attention heads 52, the processing circuitry 12 is configured to compute a plurality of attention error values 84 for each of the predefined sparsity patterns 82 using a respective plurality of calibration-time inferencing inputs 78. The processing circuitry 12, in such examples, may be configured to select the predefined sparsity pattern 82 with the lowest mean attention error value. By sampling over multiple calibration-time inferencing inputs 78 for each attention head 52, the processing circuitry 12 may obtain a more accurate selection of the predefined sparsity pattern 82 that has the highest performance across a variety of different inferencing inputs.

In the example of FIG. 5, the processing circuitry 12 is configured to compute the sparsity pattern search space 80 for each of the attention heads 52, starting from an initialized search space 70 that includes a plurality of candidate sparsity patterns 72. The processing circuitry 12 is further configured to narrow the initialized search space 70 to obtain the sparsity pattern search space 80. The processing circuitry 12 includes a GPU 12B in the example of FIG. 5. The processing circuitry 12 is configured to compute the sparsity pattern search space 80 at least in part by, for each of the candidate sparsity patterns 72, determining a respective number of FLOPs 76 performed at a GPU kernel 74 of the GPU 12B during a computation of the calibration-phase sparse attention matrix 86 at the attention head 52 using the candidate sparsity pattern 72. The GPU kernel 74 used to compute the calibration-phase sparse attention matrix 86 for a candidate sparsity pattern 72 may, for example, be the block-sparse FlashAttention kernel 32 or the vertical-slash sparse FlashAttention kernel 36 shown in FIG. 1. Thus, the processing circuitry 12 is configured to select a plurality of candidate sparsity patterns 72 that have low overhead. The calibration-phase sparse attention matrices 86 that are used to compute the numbers of FLOPs 76 may be reused in the computation of the attention error values 84.

The following example algorithm summarizes the process of selecting the sparsity pattern 54 during the calibration stage 56:

Algorithm 1: Kernel-Aware Sparse Pattern Search

```
Input: Q, K, V ∈ [symbol]   ^{S×d}^{ₕ}, patterns p, search space ρ, target FLOPs t, initialized search
space σ
# Build kernel-aware search space
for i ← |σ| do
  tᵢ ← FLOPs_in_kernel(σᵢ)
  while |tᵢ − t| > ∈ do
    σᵢ ← ChangeSpace(σᵢ, pᵢ)
    tᵢ ← FLOPs_in_kernel(σᵢ)
  end while
  ρ ← ρ ∪ σᵢ
end for
# Search for optimal head pattern
p_{best} ← Ø
y ← SoftMax(QK^{T}/\sqrt{d})
for i ← 1 to |ρ| do
  yᵢ ← SparseAttention(QK^{T}/\sqrt{d}, ρᵢ)
  p_{best} ← argmin(yᵢ − y, p_{best})
end for
return p_{best}
```

In the above algorithm, S is the length of the input vector sequence and dₕ is the size of the hidden dimension of the input vector.

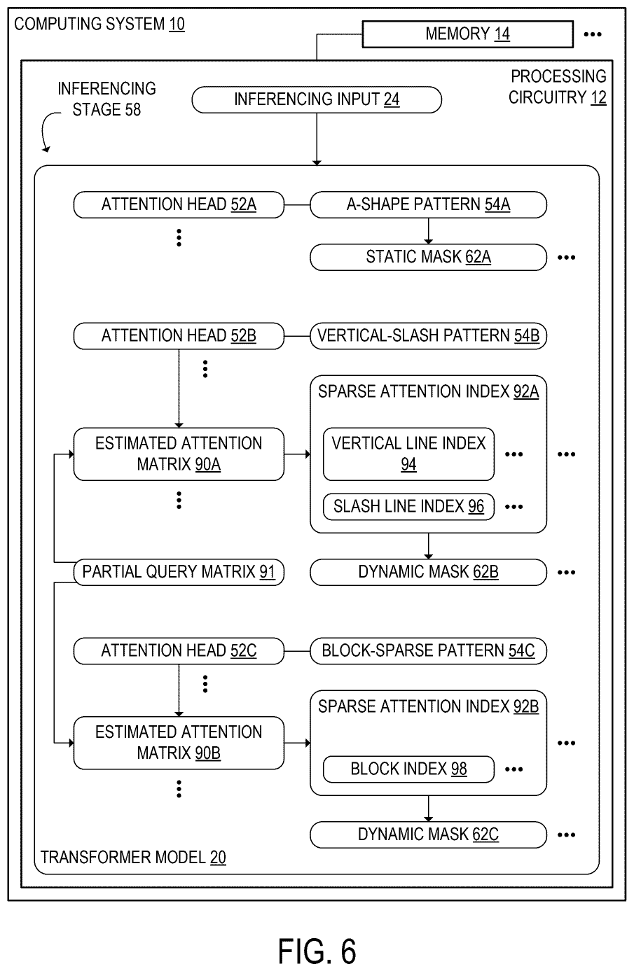

FIG. 6 schematically shows the computing system 10 when the masks 62 associated with the attention heads 52 are computed during the inferencing stage 58. In the example of FIG. 6, the transformer model 20 includes a plurality of attention heads 52A that have the A-shape pattern 54A, a plurality of attention heads 52B that have the vertical-slash pattern 54B, and a plurality of attention heads 52C that have the block-sparse pattern 54C.

For each of the attention heads 52A that has the A-shape pattern 54A selected as the sparsity pattern 54, the processing circuitry 12 is configured to mask that attention head 52A with a static mask 62A when pre-filling the context 60. Since the A-shape pattern 54A is consistent across the attention heads 52A and between different inferencing inputs 24, the static mask 62A is used to mask out each of the attention scores that is outside the A-shape. Thus, when the static mask 62A is used during the inferencing stage 58, the attention scores along the diagonal and the first column of the attention matrix are retained and the other attention scores are masked out.

For each of the attention heads 52B or 52C for which the vertical-slash pattern 54B or the block-sparse pattern 54C is selected, the processing circuitry 12 is further configured to compute a sparse attention index 92A or 92B associated with that attention head. The sparse attention index 92A is computed for the vertical-slash pattern 54A and includes one or more vertical line indices 94 of one or more respective vertical lines 55 included in the vertical-slash pattern 54B. In addition, the sparse attention index 92A includes one or more slash line indices 96 of one or more respective slash lines 57 included in the vertical-slash pattern 54B. The sparse attention index 92B is computed for the block-sparse pattern 54C and includes one or more block indices 98 of one or more respective blocks 59 included in the block-sparse pattern 54C.

For each of the attention heads 52B or 52C that has the vertical-slash pattern 54B or the block-sparse pattern 54C, the processing circuitry 12 is further configured to compute a dynamic mask 62B or 62C based at least in part on the sparse attention index 92A or 92B. The processing circuitry 12 is further configured to mask that attention head 52B or 52C with the dynamic mask 62B or 62C when pre-filling the context 60. Thus, using the dynamic mask 62B or 62C, the processing circuitry 12 is configured to sparsify the attention weights in a manner that corresponds to the sparsity pattern 54 of the attention head 52.

In the example of FIG. 6, the processing circuitry 12 is configured to compute the sparse attention index 92A or 92B at least in part by computing an estimated attention matrix 90A or 90B associated with the attention head 52B or 52C. The estimated attention matrix 90A or 90B is computed based at least in part on a partial query matrix 91 that is smaller than the full query matrix Q. The processing circuitry 12 is further configured to compute the sparse attention index 92A or 92B based at least in part on the estimated attention matrix 90A or 90B. Thus, the processing circuitry 12 may compute the sparse attention index 92A or 92B more efficiently.

The following algorithm provides an example process by which the processing circuitry 12 may compute the sparse attention index 92A, the sparse attention scores 64, and sparse mixed scores and values for an attention head 52A that has the vertical-slash pattern 54B:

Algorithm 2: Vertical-Slash Head

Input: Q, K, V ∈ [symbol] ^{S×d}^{ₕ}, kᵥ, kₛ ∈ [symbol]
# Approximate vertical and slash pattern (last_q = 64)
Â ← SoftMax(Q_{[-last}_{_{—}}_{q:]}K^{T}/\sqrt{d} + m_{causal}
# Indices of top kᵥ vertical lines, sum in vertical
iᵥ ← argtopk(sumᵥ(Â), kᵥ)
# Indices of top kₛ slash lines, sum in slash
iₛ ← argtopk(sumₛ(Â), kₛ)
# Build sparse attention index
iᵥₛ ← sparseformat(iᵥ, iₛ)
# Final dynamic sparse attention scores (only index block)
A ← SoftMax(sparse(QK^{T}, iᵥₛ)/\sqrt{d})
# Sparse mixed scores and values
y ← sparse(AV, iᵥₛ)
return y

In the above algorithm, m_{causal} is a causal attention mask. The function sparseformat(⋅,⋅) converts iᵥ and iₛ into a two-dimensional sparse index and stores that index in the resulting sparse format. The function sparse(⋅,⋅) indicates that the first term is sparsely computed using the sparsity index given in the second term.

As shown in Algorithm 2, due to the continuity of vertical and slash lines, matrix multiplication is applied to the last query vector Q_{[-last_q:]} (the partial query matrix 91 in this example) and key vector K to produce the estimated attention matrix Â, which, in turn, is used to determine the respective indices iᵥ and iₛ for the vertical and slash lines. The estimated attention matrix Â is an estimate of the attention scores within the lower quadrilateral region 53 of the attention weight matrix shown in FIG. 3B. After obtaining the sparse indices for the vertical and slash lines, the processing circuitry 12 is configured to convert those indices into a sparse format iᵥₛ. Using these sparse indices, the processing circuitry 12 is further configured to perform block-sparse computation of the attention weights and attention output.

The following algorithm provides an example process by which the processing circuitry 12 may compute the sparse attention index 92B, the sparse attention scores 64, and sparse mixed scores and values for an attention head 52B that has the block-sparse pattern 54C:

Algorithm 3: Block-Sparse Head

Input: Q, K, V ∈ [symbol] ^{S×d}^{ₕ}, k_{b} ∈ [symbol]
# Approximate block-sparse pattern (block_size = 64)
\hat{Q} ← MeanPooling(Q, block_size)
\hat{K} ← MeanPooling(K, block_size)
Â ← SoftMax(\hat{Q}\hat{K}^{T}/\sqrt{d} + m_{causal})
# Indices of top k blocks
i_{b} ← argtopk(Â, k_{b})
# Build sparse attention index
i_{b} ← sparseformat(i_{b})
# Final dynamic sparse attention scores (only index block)
A ← SoftMax(sparse(QK^{T}, i_{b})/\sqrt{d})
# Sparse mixed scores and values
y ← sparse(AV, i_{b})
return y

Per Algorithm 3, mean pooling is applied to Q and K to obtain \hat{Q} and \hat{K}, respectively. \hat{Q} is the partial query matrix 91 in the example of Algorithm 3. Those two matrices are then multiplied to obtain the estimated block-level attention weights Â. Since the mean pooling and matrix multiplication operations are commutative, the resulting attention weights are approximately equivalent to the full attention weights after mean pooling. This approximation allows the block-sparse pattern of the attention weights to be approximated with low overhead. In addition, a sparse index i_{b} is constructed and is used to compute the sparse attention weights and the attention output.

The experiments were discussed below to evaluate the effectiveness and efficiency of MInference. In these experiments, MInference was evaluated on four long-context benchmarks: InfiniteBench, RULER, Needle In A Haystack, and PG-19. These benchmarks cover long-context QA, multi-hop QA, math reasoning, aggregation tasks, summarization, retrieval tasks, and code debugging, allowing assessment of MInference's effectiveness across a wide range of long-context scenarios. In the efficiency experiments, the end-to-end latency of MInference was explored, along with the latencies of different inferencing stages.

The experiments used four long-context LLMs: LLaMA-3-8B-Instruct-262K1, LLaMA-3-8B-Instruct-1048K2, GLM-4-9B-1M, and Yi-9B-200K. Greedy decoding was used in the experiments in order to obtain stable results. The target FLOPs t were set to 1K global tokens and 4K local windows in the A-shape pattern. The settings of last_q=64 and block_size=64 were used in the Vertical-Slash and Block-Sparse patterns, respectively. The latency experiments were conducted on a single NVIDIA A100 GPU in the bfloat16 format.

The following benchmarks were used:
InfiniteBench: This benchmark includes 10 tasks, including retrieval tasks such as PassKey retrieval, Number retrieval, and KV retrieval, as well as representative realistic tasks like question answering, coding, dialogue, and summarization. The average context length of InfiniteBench is about 214K tokens.
RULER: This long-context benchmark includes 4 categories and 13 complex tasks, including retrieval, multi-hop tracing and aggregation, and QA tasks. RULER includes subsets with different prompt lengths up to 128K tokens.
Needle In A Haystack: A long-context retrieval benchmark that tests LLM performance with varying context window sizes of up to 1M tokens. In the Needle In A Haystack task, information is placed at various context positions.
PG-19: A benchmark used for long-context language modeling tasks with prompts up to 100K tokens.

Four training-free sparse attention approaches were used as baselines: (1) Stream-LLM, which corresponds to the A-shape pattern. 1K global tokens and 4K local windows were used in all experiments. (2) StreamingLLM w/ dilated, which sets dilated local windows with intervals in the local window direction. 1K global tokens and 8 k dilated attention windows with an interval of 1 were used. (3) StreamingLLM w/ strided, which retains local windows while adding dilated attention. 1K global tokens, 2K local windows, and 4K dilated attention windows were used with an interval of 1. (4) InfLLM, which uses a memory unit to process long streaming sequences. 128 global tokens and 8K local windows were used for InfLLM in all experiments. (5) MInference w/ static, which utilizes static sparse indices in the vertical-slash and block-sparse heads.

The following Tables 2A-2C show the result obtained using the different models and baselines on InfiniteBench.

TABLE 2A

| Method | En.Sum | En.QA | En.MC | En.Dia |
|---|---|---|---|---|
| LLaMA-3-8B- | 20.4 | 12.4 | 67.3 | 6.0 |
| 262K | | | | |
| StreamingLLM | 21.0 | 8.2 | 40.2 | 10.0 |
| StreamingLLM | 20.1 | 9.4 | 44.5 | 15.5 |
| w/dilated | | | | |
| StreamingLLM | 17.3 | 8.2 | 27.5 | 14.5 |
| w/strided | | | | |
| InfLLM | 24.1 | 7.8 | 45.0 | 6.0 |
| MInference w/ | 19.9 | 8.6 | 43.2 | 3.5 |
| static | | | | |
| MInference | 20.5 | 12.9 | 65.9 | 7.5 |
| Yi-9B-200K | 8.2 | 10.6 | 64.2 | 1.0 |
| StreamingLLM | 5.4 | 14.2 | 38.0 | 4.0 |
| StreamingLLM | 5.7 | 4.2 | 15.0 | 0.0 |
| w/dilated | | | | |
| StreamingLLM | 6.1 | 4.5 | 9.8 | 0.0 |
| w/strided | | | | |
| InfLLM | 6.3 | 13.0 | 45.9 | 2.5 |
| MInference w/ | 5.8 | 12.6 | 48.5 | 3.0 |
| static | | | | |
| MInference | 7.9 | 11.2 | 64.2 | 1.0 |
| GLM-4-9B-1M | 28.3 | 9.7 | 68.6 | 39.5 |
| StreamingLLM | 27.7 | 6.4 | 40.2 | 12.5 |
| InfLLM | 28.0 | 7.3 | 45.0 | 14.0 |
| MInference | 28.8 | 9.6 | 68.6 | 38.5 |

TABLE 2B

| Method | Zh.QA | Code.Debug | Math.Find |
|---|---|---|---|
| LLaMA-3-8B- | 12.9 | 22.1 | 26.6 |
| 262K | | | |
| StreamingLLM | 10.4 | 25.9 | 30.0 |
| StreamingLLM w/ | 11.2 | 20.5 | 27.5 |
| dilated | | | |
| StreamingLLM w/ | 11.2 | 19.5 | 27.5 |
| strided | | | |
| InfLLM | 11.4 | 19.5 | 32.9 |
| MInference w/ | 8.9 | 20.6 | 25.1 |
| static | | | |
| MInference | 12.5 | 22.3 | 33.1 |
| Yi-9B-200K | 17.3 | 21.3 | 23.4 |
| StreamingLLM | 18.8 | 18.8 | 22.3 |
| StreamingLLM w/ | 18.2 | 0.0 | 2.9 |
| dilated | | | |
| StreamingLLM w/ | 16.9 | 0.0 | 3.1 |
| strided | | | |
| InfLLM | 21.5 | 20.6 | 34.6 |
| MInference w/ | 12.6 | 20.8 | 25.1 |
| static | | | |
| MInference | 17.9 | 24.1 | 23.1 |
| GLM-4-9B-1M | 12.1 | 29.4 | 38.9 |
| StreamingLLM | 10.8 | 27.7 | 21.1 |
| InfLLM | 10.7 | 27.9 | 39.4 |
| MInference | 12.0 | 30.7 | 39.1 |

TABLE 2C

| Method | Retr.PassKey | Retr.Num | Retr.KV | Avg. |
|---|---|---|---|---|
| LLaMA-3-8B- | 100.0 | 100.0 | 14.4 | 38.2 |
| 262K | | | | |
| StreamingLLM | 86.8 | 5.1 | 0.8 | 23.8 |
| StreamingLLM | 5.0 | 87.5 | 0.5 | 24.2 |
| w/dilated | | | | |
| StreamingLLM | 4.0 | 2.1 | 1.0 | 13.3 |
| w/strided | | | | |
| InfLLM | 100.0 | 100.0 | 1.2 | 34.8 |
| MInference w/ | 92.4 | 96.3 | 0.2 | 31.9 |
| static | | | | |
| MInference | 100.0 | 100.0 | 12.8 | 38.8 |
| Yi-9B-200K | 99.8 | 100.0 | 28.8 | 37.5 |
| StreamingLLM | 39.2 | 6.1 | 1.6 | 16.8 |
| StreamingLLM | 0.0 | 0.0 | 0.0 | 4.2 |
| w/dilated | | | | |
| StreamingLLM | 1.5 | 0.0 | 0.0 | 4.6 |
| w/strided | | | | |
| InfLLM | 85.3 | 88.1 | 1.4 | 31.9 |
| MInference w/ | 60.9 | 38.5 | 1.0 | 22.9 |
| static | | | | |
| MInference | 99.5 | 100.0 | 27.6 | 37.7 |
| GLM-4-9B-1M | 100.0 | 100.0 | 41.0 | 46.7 |
| StreamingLLM | 97.1 | 25.6 | 0.6 | 27.0 |
| InfLLM | 98.0 | 100.0 | 2.6 | 37.3 |
| MInference | 100.0 | 100.0 | 43.0 | 47.0 |

As shown in Tables 2A-2C, MInference outperforms the baselines on the majority of the InfiniteBench tasks. Surprisingly, MInference achieves higher accuracy than dense attention on some tasks, resulting in MInference having the highest average accuracy on each of the three LLMs. This increased accuracy relative to dense attention is likely due to the sparsification of the attention matrices increasing the signal-to-noise ratio of attention computation. MInference not only performs well in natural language tasks such as summarization, QA, and code, but also maintains the original model's performance on retrieval-related tasks. Baseline methods such as StreamingLLM, on the contrary, struggle with these retrieval tasks.

The following Tables 3A-3B show the results of MInference and the baseline methods on the RULER benchmark.

TABLE 3A

| Methods | Claimed | Effective | 4K | 8K |
|---|---|---|---|---|
| LLaMA-3-8B- | 262K | 16K | 97.2 | 91.8 |
| 262K | | | | |
| StreamingLLM | | 4K | 97.2 | 38.1 |
| StreamingLLM | | <4K | 23.4 | 0.7 |
| w/dilated | | | | |
| StreamingLLM | | <4K | 2.0 | 0.7 |
| w/strided | | | | |
| InfLLM | | 4K | 89.4 | 79.8 |
| MInference | | 32K | 97.7 | 91.2 |
| Yi-9B-200K | 200K | 8K | 91.9 | 90.2 |
| StreamingLLM | | 4K | 91.9 | 37.8 |
| StreamingLLM | | <4K | 44.8 | 42.8 |
| w/dilated | | | | |
| StreamingLLM | | <4K | 2.6 | 0.7 |
| w/strided | | | | |
| InfLLM | | <4K | 80.3 | 83.9 |
| MInference | | 8K | 92.3 | 89.7 |
| GLM-4-9B-1M | 1M | 64K | 93.8 | 91.6 |
| StreamingLLM | | 4K | 93.8 | 66.9 |
| InfLLM | | 8K | 94.7 | 89.5 |
| MInference | | 64K | 94.6 | 93.1 |

TABLE 3B

| Methods | 16K | 32K | 64K | 128K | Avg. |
|---|---|---|---|---|---|
| LLaMA-3-8B- | 87.3 | 80.8 | 77.4 | 72.2 | 84.4 |
| 262K | | | | | |
| StreamingLLM | 37.5 | 17.2 | 14.2 | 9.4 | 35.0 |
| StreamingLLM | 1.4 | 18.8 | 16.5 | 15.6 | 12.7 |
| w/dilated | | | | | |
| StreamingLLM | 0.6 | 0.6 | 0.7 | 1.3 | 1.0 |
| w/strided | | | | | |
| InfLLM | 70.1 | 55.6 | 43.0 | 39.5 | 62.9 |
| MInference | 88.5 | 85.0 | 82.3 | 77.6 | 87.0 |
| Yi-9B-200K | 78.8 | 76.3 | 68.1 | 62.9 | 78.1 |
| StreamingLLM | 33.9 | 18.6 | 13.0 | 12.8 | 34.3 |
| StreamingLLM | 38.5 | 29.8 | 26.8 | 23.9 | 34.4 |
| w/dilated | | | | | |
| StreamingLLM | 0.6 | 0.6 | 1.2 | 0.5 | 1.1 |
| w/strided | | | | | |
| InfLLM | 60.7 | 45.2 | 38.6 | 30.2 | 56.5 |
| MInference | 79.0 | 73.8 | 64.7 | 56.9 | 74.7 |
| GLM-4-9B-1M | 89.3 | 87.4 | 85.2 | 80.8 | 88.0 |
| StreamingLLM | 58.5 | 51.4 | 45.9 | 39.1 | 59.3 |
| InfLLM | 76.4 | 66.5 | 56.8 | 53.5 | 72.9 |
| MInference | 91.0 | 89.6 | 85.5 | 84.0 | 89.6 |

Tables 3A-3B show that MInference effectively maintains the long-context performance even in the complex multi-hop or aggregation tasks included in RULER. MInference even outperforms the original full attention for LLaMA-3-8B-262K and GLM-4-9B-1M on testing lengths beyond 32K, achieving effective context windows of 32K and 64K (performance over 85% is considered effective).

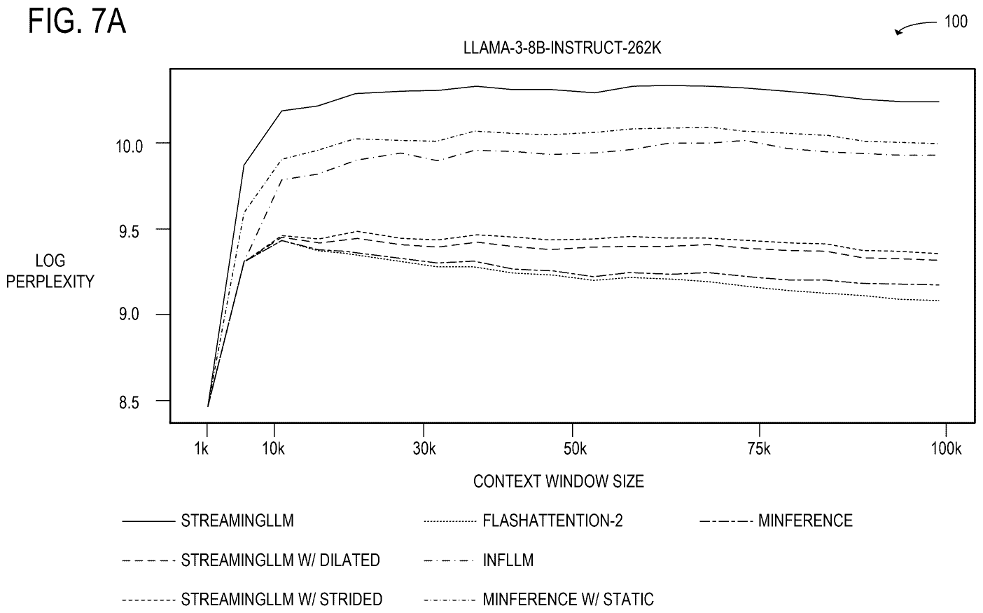

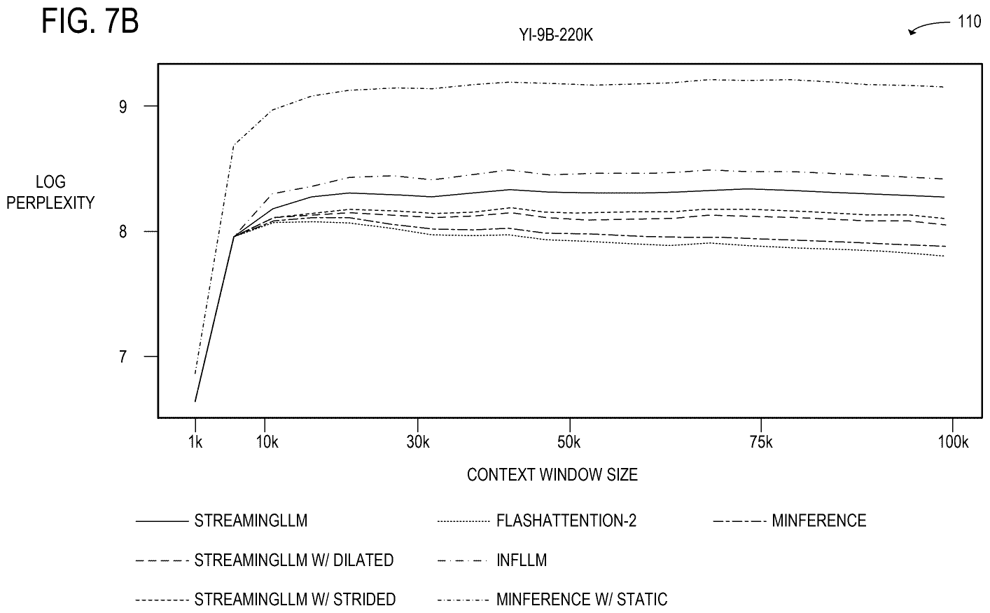

MInference was also evaluated against StreamingLLM, StreamingLLM w/ dilated, StreamingLLM w/ strided, FlashAttention-2, InfLLM, and MInference w/static on a language modeling task using the PG-19 dataset. FIGS. 7A-7B show respective plots 100 and 110 of the results of this experiment for LLaMA-3-8B-Instruct-262K and Yi-9B-200K. As shown in the plots 100 and 110, MInference has the lowest perplexity of the sparse approaches and has only slightly higher perplexity than the full attention baseline FlashAttention-2. For prompts of 100K tokens, the log perplexity of MInference is only 0.2 higher than the full attention, but lower than StreamingLLM for 0.25 and 0.75 on the Yi-9B-200K and LLaMA-3-8B-262K models, respectively.

In the Needle In A Haystack task, MInference retains the ability to effectively process tokens at different positions across various context windows, ranging from 1K to 1M tokens. Methods such as StreamingLLM, despite reducing latency, experience a rapid decline in performance once the “needle” information is outside the range of global tokens and local windows.

To evaluate the contributions of different components in MInference, four variants were used for an ablation study: (1) MInference w/ static, which uses a static sparse mask in the vertical-slash and block sparse patterns, as discussed above; (2) MInference w/ only A-shape, which is equivalent to StreamingLLM; (3) MInference w/ only block-sparse, which uses only the block-sparse pattern in the dynamic sparse attention computation; and (4) MInference w/ only vertical-slash, which uses only the vertical-slash pattern in the dynamic sparse attention computation. Results for MInference w/ static and MInference w/ only A-shape are shown in Tables 2A-2C and 3A-3B. Tables 4A-4B, presented below, compare MInference to MInference w/ only block-sparse and MInference w/ only vertical-slash.

TABLE 4A

| Method | En. Sum | En. QA | En. MC | En. Dia | Zh. QA | Code. Debug |
|---|---|---|---|---|---|---|
| MInference | 20.5 | 12.9 | 65.9 | 7.5 | 12.5 | 22.3 |
| MInference | 12.4 | 3.4 | 5.7 | 6.0 | 3.1 | 12.2 |
| w/only | | | | | | |
| block- | | | | | | |
| sparse | | | | | | |
| MInference | 19.6 | 12.0 | 62.1 | 9.5 | 11.7 | 21.6 |
| w/only | | | | | | |
| vertical- | | | | | | |
| slash | | | | | | |

TABLE 4B

| Method | Math.Find | Retr.PassKey | Retr.Num | Retr.KV | Avg. |
|---|---|---|---|---|---|
| MInference | 33.1 | 100.0 | 100.0 | 12.8 | 38.8 |
| MInference | 24.0 | 59.5 | 60.3 | 0.0 | 18.7 |
| w/only | | | | | |
| block- | | | | | |
| sparse | | | | | |
| MInference | 29.1 | 100.0 | 100.0 | 5.0 | 37.1 |
| w/only | | | | | |
| vertical- | | | | | |
| slash | | | | | |

The results of the ablation study first demonstrate that using static indices significantly degrades LLM performance, especially in highly dynamic tasks like KV retrieval, where accuracy nearly drops to zero. This drop highlights the utility of a dynamic strategy, and the effectiveness of the dynamically built sparse indices used in MInference. Additionally, removal of any of the three sparsity patterns leads to performance degradation. Specifically, MInference w/ only A-shape can only capture information within local windows. MInference w/ only block-sparse also results in significantly decreased performance. MInference w/ only vertical-slash manages to preserve most of the performance due to its balance between dynamicity and local window attention but still falls behind the full version of MInference.

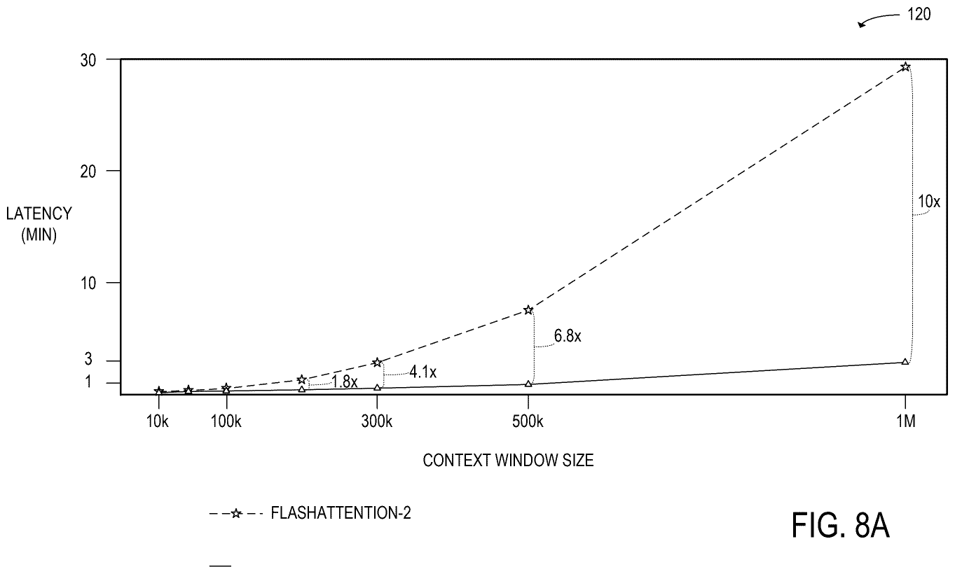

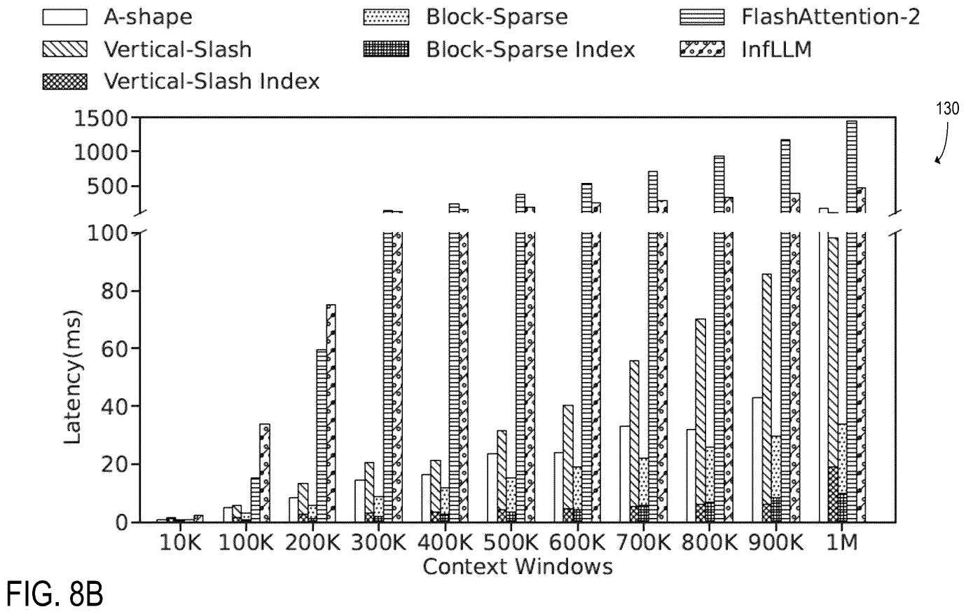

FIGS. 8A-8B show respective plots 120 and 130 of the latency of MInference compared to other methods across different context windows on a single A100. FIG. 8A shows a plot 120 of pre-filling latency as a function of context window size for MInference and FlashAttention-2. In addition, the plot 130 shown in FIG. 8B compares the latencies of the different sparsity patterns to the FlashAttention-2 and InfLLM baselines. For the vertical-slash pattern and the block-sparse pattern, the plot 130 depicted in FIG. 8B also shows the breakdown of the latency into time spent constructing the sparse attention index and the time spent computing the sparse attention scores after the sparse attention index has been constructed.

At 100K, 300K, 500K, and 1M tokens, MInference achieves speedups of 1.8×, 3.4×, 6.8×, and 10×, respectively, as shown in FIG. 8A. MInference reduces the pre-filling latency from 30 mins to 3 mins on a single A100 GPU for a prompt of 1M tokens. By further utilizing tensor parallelism and context parallelism, this latency can be reduced to 40 seconds on 8 A100 GPUs. Thus, MInference significantly lowers the deployment cost of long-context LLMs and enhances the user experience.

As shown in FIG. 8B, about 5%-20% of the latency for the vertical-slash pattern and the block-sparse pattern is spent on dynamic sparse index building, while the remaining time is spent on dynamic sparse attention computation. Vertical-slash is the slowest among the three patterns, but it still achieves a 13× speedup compared to FlashAttention for context windows under 1M. A-shape is slightly faster than vertical-slash, but at 1M, A-shape is 50% slower than vertical-slash. Block-sparse is the fastest, achieving a 30× speedup over FlashAttention for context windows under 1M tokens. The estimation and index-building time for the dynamic sparse pattern accounts for approximately 5%-15% and 25% of the total time for the vertical-slash and block-sparse patterns, respectively. The index-building overhead is higher for block-sparse mainly due to the time-consuming MeanPooling and block-level matrix multiplication operations. Additionally, the memory overhead for sparse indexing is relatively small, remaining within 160 MB for a LLaMA-3-8B model in 1M-token context.

Another experiment combined MInference with the KV cache compression method SnapKV. Tables 5A-5B show the results of MInference with SnapKV on InfiniteBench, compared to LLaMA-3-8B-Instruct-262K with SnapKV and dense attention.

TABLE 5A

| Method | En. Sum | En. QA | En. MC | En. Dia | Zh. QA | Code. Debug |
|---|---|---|---|---|---|---|
| LLaMA-3 | 18.0 | 11.8 | 65.5 | 2.5 | 12.0 | 21.3 |
| w/SnapKV | | | | | | |
| MInference | 18.9 | 11.7 | 66.4 | 6.5 | 12.1 | 21.8 |
| w/SnapKV | | | | | | |

TABLE 5B

| Method | Math.Find | Retr.PassKey | Retr.Num | Retr.KV | Avg. |
|---|---|---|---|---|---|
| LLaMA-3 | 26.6 | 100.0 | 100.0 | 1.8 | 36.0 |
| w/SnapKV | | | | | |
| MInference | 33.1 | 100.0 | 100.0 | 2.0 | 37.3 |
| w/SnapKV | | | | | |

Tables 5A-5B show that for most tasks, performance remains nearly unchanged, with the average score even showing a slight increase compared to full attention. The KV compression experiment further demonstrates the practical value of MInference when serving long-context LLMs.

An experiment was also performed to evaluate the scaling of MInference to larger LLMs. This experiment used LLaMA-3-70B. Tables 6A-6B show the results of LLaMA-3-70B with MInference on InfiniteBench, compared to full attention, StreamingLLM, and InfLLM baselines.

TABLE 6A

| Method | En. Sum | En. QA | En. MC | En. Dia | Zh. QA | Code. Debug |
|---|---|---|---|---|---|---|
| LLaMA-3- | 20.7 | 10.3 | 84.2 | 9.5 | 14.0 | 33.2 |
| 70B-262K | | | | | | |
| StreamingLLM | 20.5 | 8.5 | 52.0 | 10.0 | 12.6 | 27.4 |
| InfLLM | 24.1 | 8.1 | 57.0 | 10.0 | 12.9 | 27.4 |
| MInference | 20.6 | 10.1 | 83.4 | 10.0 | 14.1 | 34.1 |

TABLE 6B

| Method | Math.Find | Retr.PassKey | Retr.Num | Retr.KV | Avg. |
|---|---|---|---|---|---|
| LLaMA-3- | 61.7 | 97.0 | 100.0 | 34.0 | 46.5 |
| 70B-262K | | | | | |
| Stream- | 61.1 | 14.0 | 10.0 | 0.0 | 21.6 |
| ingLLM | | | | | |
| InfLLM | 52.3 | 100.0 | 100.0 | 0.0 | 39.2 |
| MInference | 61.9 | 100.0 | 100.0 | 39.0 | 47.3 |

As shown in Tables 6A-6B, MInference maintains strong performance even in larger models. Notably, in dynamic tasks such as KV retrieval, MInference can match or even slightly improve performance compared to full attention. In contrast, baselines such as InfLLM generally struggle with tasks such as KV retrieval.

As shown from the above experimental results, MInference effectively accelerates the inference of long-context LLMs, facilitating their deployment and application. By enabling lower latency, MInference can reduce the deployment costs of LLMs, especially for long-context LLMs, helping to democratize access to advanced language modeling capabilities. MInference also promotes further research and development in related fields.

Additional implementation details used in the above experiments are provided below. The experiments conducted herein were based on three state-of-the-art long-context LLMs: (1) LLaMA-3-8B-Instruct-262K, which is a LLaMA-3 variant with further NTK-aware interpolation and minimal fine-tuning with Ring Attention, and which achieved state-of-the-art results on long-context assessments such as the Needle In A Haystack test; (2) LLaMA-3-8B-Instruct-1048K, which is similar to LLaMA-3-8B-Instruct-262K, but supports context lengths up to 1M tokens; and (3) Yi-9B-200K, which balances long-context performance with general capabilities. To achieve stable results, greedy decoding was used in all tests. Kernel implementations were developed and optimized based on the dynamic sparse compiler PIT in the Triton language. The latency experiments were performed on a single NVIDIA A100 GPU using bfloat16. A custom implementation of attention in PyTorch was used, building on FlashAttention and Triton.

The target FLOPs t were set to be 1K global tokens and 4K local window tokens in the A-shape pattern. The step size of ChangeSpace was set to 50. The sparsity pattern search space used in the experiments is shown below in Table 7. In this table, the search space coordinates for the A-shape pattern represent the global tokens and the local window number, the search space coordinates for the vertical-slash pattern represent the top k numbers of vertical and diagonal lines, and the search space coordinates for the block-sparse pattern represent the top-k number of blocks retained.

TABLE 7

| Pattern | Search space |
|---|---|
| A-shape | {(1024, 4096)} |
| Vertical-slash | {(30, 2048), (100, 1800), (500, 1500), |
| | (3000, 200)} |
| Block-sparse | {100} |

To enable running 1M prompt inference on a single A100, the following optimizations were implemented for LLaMA-3-8B-Instruct-262K:
(1) Tensor splitting: Attention was split by head and the multi-layer perceptron (MLP) was split by sequence dimension. In long-context scenarios, where computation is the bottleneck, this splitting keeps GPU utilization at 100%, and the overhead of splitting is negligible.
(2) Reduction of intermediate variables: The allocation of intermediate variables was minimized by removing the attention mask and implementing causal mask logic within the kernel.
(3) Elimination of unnecessary computations: In long-context scenarios, only the logits corresponding to the last token in the prompt phase are meaningful. Thus, only the computation of the LM head linear layer was retained for the last token.

The block-sparse kernel implementation is based on the Triton version of the FlashAttention kernel. With the selected block index as an additional input, each thread block loops through the top K blocks in a row. The latency of the block-sparse FlashAttention kernel 32 is linearly related to the number of blocks, and the speedup ratio (compared to the dense FlashAttention kernel) is approximated as:

$${s}_{p} = \frac{S}{2 B \times {k}_{b}}$$

where B is the block size.

The vertical-slash attention is computed using two custom kernels: a vertical-slash sparse index kernel 34 and a vertical-slash sparse FlashAttention kernel 36. The vertical-slash sparse index kernel 34 builds the index for each row of blocks. Since a slash line segment can be masked by a square block, the attention mask is a mix of blocks and columns. A point-range two-way merge algorithm is applied where vertical indexes are treated as points and slash indexes are converted to ranges given the row index. The output of the vertical-slash sparse index kernel 34 includes two parts: merged ranges and separate column indices, where the ranges are represented by block indices. The time complexity to build an index for a row is O(kᵥ+kₛ).

An example algorithm that implements the vertical-slash sparse index kernel 34 is provided below:

Algorithm 4: Vertical-Slash Index

```
Input: vertical indices iᵥ ∈ [symbol]  ^{k}^{ᵥ}, slash indices is ∈ [symbol]  ^{k}^{ₛ}
# Sort vertical and slash indices
iᵥ ← IncrementalSort(iᵥ)
iₛ ← DescendingSort(iₛ)
# Calculate block number (block_size B)
N ← [S/B]
# Initialize outputs
block count c_{blk} ∈ [symbol]  ^{N}, block index i_{blk} ∈ [symbol]  ^{N×k}^{ₛ}, column count c_{col} ∈ [symbol]  ^{N}, column
index i_{col} ∈ [symbol]  ^{N×k}^{ᵥ}
# Parallelized in GPU
for i ← 1 to N do
  jᵥ ← 1
  # Find the first slash line that crosses the row
  jₛ ← biset_left(iₛ, i × B)
  # Define the range by slash index
  ${r}_{start} ← ( i - 1 ) \times B - {i}_{s}^{{j}_{s}}$
  ${r}_{e n d} ← i \times B - {i}_{s}^{{j}_{s}}$
  # Merge points (vertical indices) and ranges (slash indices)
  while sᵥ ≤ kₛ do
    $if {j}_{v} \leq {k}_{v} and {i}_{v}^{{j}_{v}} < {r}_{end} then$
    # Record the point if not in the range
      $if {i}_{v}^{{j}_{v}} < {r}_{start} then$
        ${c}_{co l}^{i} ← {c}_{co l}^{i} + 1 , {i}_{col}^{i , {c}_{col}^{i}} ← {i}_{v}^{{j}_{v}}$
      end
      jᵥ ← jᵥ + 1
    else
      sᵥ ← sᵥ + 1
      # Update the range
      $if ( i - 1 ) \times B - {i}_{s}^{{j}_{s}} > {r}_{end} then$
        # Record the last range
        s ← rₛₜₐᵣₜ
        while s < r_{end} do
          ${c}_{blk}^{i} ← {c}_{blk}^{i} + 1$
          ${i}_{b l k}^{i , {c}_{b l k}^{i}} ← s$
          s ← s + B
        end while
        # Calculate the new range
        ${r}_{start} ← ( i - 1 ) \times B - {i}_{s}^{{j}_{s}}$
        ${r}_{e n d} ← i \times B - {i}_{s}^{{j}_{s}}$
      else
        # Extend the range
        r_{end} ← r_{end} + B
      end
    end
  end while
  # Record the last range
  s ← rₛₜₐᵣₜ
  while s < r_{end} do
    ${c}_{blk}^{i} ← {c}_{blk}^{i} + 1$
    ${i}_{b l k}^{i , {c}_{b l k}^{i}} ← s , s ← s + B$
  end while
end for
return c_{blk}, i_{blk}, c_{col}, i_{col}
```

The vertical-slash sparse FlashAttention kernel 36 is a mix of the block-sparse FlashAttention attention kernel 32 and the PIT sparse attention kernel. PIT loads sparse data into dense compute blocks via a Permutation Invariant Transformation. A thread block first loops through the block indices and then loops through the column indices grouped by block size. The latency of this hybrid kernel is linearly related to the total area of blocks and columns.

An example algorithm that implements the vertical-slash sparse FlashAttention kernel 36 is provided below:

Algorithm 5: Vertical-Slash Flash Attention

```
Input: Q, K, V ∈ [symbol]  ^{s×d}^{ₕ}, block count c_{blk} ∈ [symbol]  ^{N}, block index i_{blk}
∈ [symbol]  ^{N×k}^{ₛ}, column
count c_{col} ∈ [symbol]  ^{N}, column index i_{col} ∈ [symbol]  ^{N×k}^{ᵥ}
Scale τ ← \sqrt{1/dₕ}
Initialize O ← (0)^{S×d}^{ₕ} ∈ [symbol]  ^{S×d}^{ₕ}
# Parallelized in GPU
for i ← 1 to N do
  Load Q_{chip} ← Q^{i×B:(i+1)×B} ∈ [symbol]  ^{B×d}^{ₕ}
  Initialize O_{chip} ← (0)^{B×d}^{ₕ} ∈ [symbol]  ^{B×d}^{ₕ}
  Initialize m ← (-inf)^{B} ∈ [symbol]  ^{B}
  Initialize l ← (0)^{B} ∈ [symbol]  ^{B}
  # Loop through block indices: block sparse flash attention
  $for j ← 1 to {c}_{blk}^{i} do$
    $Block start s ← {i}_{blk}^{i , j}$
    Load K_{chip} ← K^{s:s+B} ∈ [symbol]  ^{B×d}^{ₕ}
    Load V_{chip} ← V^{s:s+B} ∈ [symbol]  ^{B×d}^{ₕ}
    $S ← τ {Q}_{c h i p} {K}_{c h i p}^{T}$
    S ← mask(S)
    ${m}_{n e w}^{i} ← max ( {m}^{i} , row max ( S ) ) ∈ {ℝ}^{B}$
    $S ← S - {m}_{n e w}^{i}$
    P ← exp(S)
    ${l}_{n e w}^{i} ← row sum ( S )$
    $α ← exp ( {m}^{i} - {m}_{n e w}^{i} )$
    ${l}^{i} ← α {l}^{i} + {l}_{n e w}^{i}$
    O_{chip} ← αO_{chip} + PV_{chip}
  end for
  # Loop through column indices: PIT sparse flash attention
  j ← 0
  $while j < {c}_{co l}^{j} do$
    $c o l s ← {i}_{col}^{i , j : j + B} ∈ {ℕ}^{B}$
    Load K_{chip} ← K^{cols} ∈ [symbol]  ^{B×d}^{ₕ}
    Load V_{chip} ← V^{cols} ∈ [symbol]  ^{B×d}^{ₕ}
    $S ← τ {Q}_{c h i p} {K}_{c h i p}^{T}$
    S ← mask(S)
    ${m}_{n e w}^{i} ← max ( {m}^{i} , row max ( S ) ) ∈ {ℝ}^{B}$
    $S ← S - {m}_{n e w}^{i}$
    P ← exp(S)
    ${l}_{n e w}^{i} ← r o w s u m ( S )$
    $α ← exp ( {m}^{i} - {m}_{n e w}^{i} )$
    ${l}^{i} ← α {l}^{i} + {l}_{n e w}^{i}$
    O_{chip} ← αO_{chip} + PV_{chip}
  j ← j + B
  # Write outputs
  O_{chip} ← diag(lⁱ)⁻¹O_{chip}
  Save Oᵢ ← O_{chip}
end for
```

Additional experimental results are provided below. In addition to the Needle In A Haystack results for LLaMA-3-Instruct-1M discussed above, InfLLM was also tested on the Needle In A Haystack task using LLaMA-3-Instruct-1M. MInference was also tested against a dense attention baseline on the Needle In A Haystack task using GLM-4-9B-1M, Yi-9B-200K, Phi-3-Mini-128K, and Qwen2-7B-128K. Compared to full attention, MInference has minimal impact on semantic information modeling across different context windows and needle depths. There is even a slight performance improvement around the 100K context length using Yi-9B-200K and Phi-3-Mini-128K.

To further analyze the role of dynamic vertical and slash lines in the vertical-slash pattern, an additional ablation study was performed. This ablation study tested the following ablations: (1) MInference w/ only vertical, which uses only vertical lines and the top-1 slash line in the vertical-slash pattern. (2) MInference w/ only slash, which only uses slash lines and the top-1 vertical line in the vertical-slash pattern. The corresponding top-K quantities are set after converting based on FLOPs in kernel. Tables 8A-8B show the results of this ablation study.

TABLE 8A

| Method | En. Sum | En. QA | En. MC | En. Dia | Zh. QA | Code. Debug |
|---|---|---|---|---|---|---|
| MInference | 20.5 | 12.9 | 65.9 | 7.5 | 12.5 | 22.3 |
| MInference | 13.7 | 6.2 | 30.1 | 2.0 | 6.5 | 7.9 |
| w/only | | | | | | |
| vertical | | | | | | |
| MInference | 18.4 | 11.5 | 60.1 | 3.0 | 11.4 | 22.1 |
| w/only | | | | | | |
| slash | | | | | | |

TABLE 8B

| Method | Math.Find | Retr.PassKey | Retr.Num | Retr.KV | Avg. |
|---|---|---|---|---|---|
| MInference | 33.1 | 100.0 | 100.0 | 12.8 | 38.8 |
| MInference | 1.7 | 65.4 | 52.7 | 0.0 | 18.6 |
| w/only | | | | | |
| vertical | | | | | |
| MInference | 28.4 | 100.0 | 100.0 | 4.2 | 35.9 |
| w/only | | | | | |
| slash | | | | | |

As shown in Tables 8A-8B, using only vertical lines results in a significant performance drop, especially in retrieval tasks, where performance is similar to only using block-sparse. In contrast, using only slash lines retains most of the performance, but in highly dynamic tasks such as KV retrieval, performance further decreases, with an average performance drop of 2.9% compared to the full MInference.

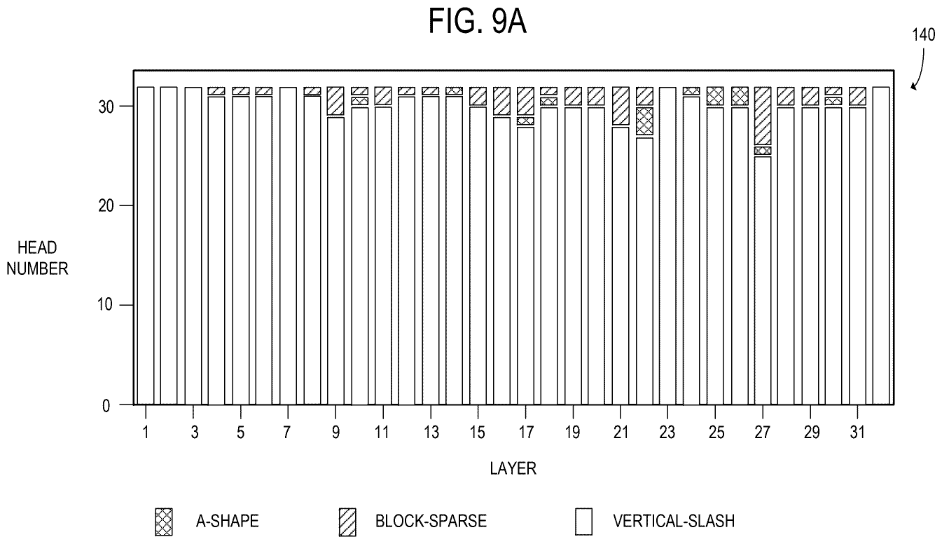

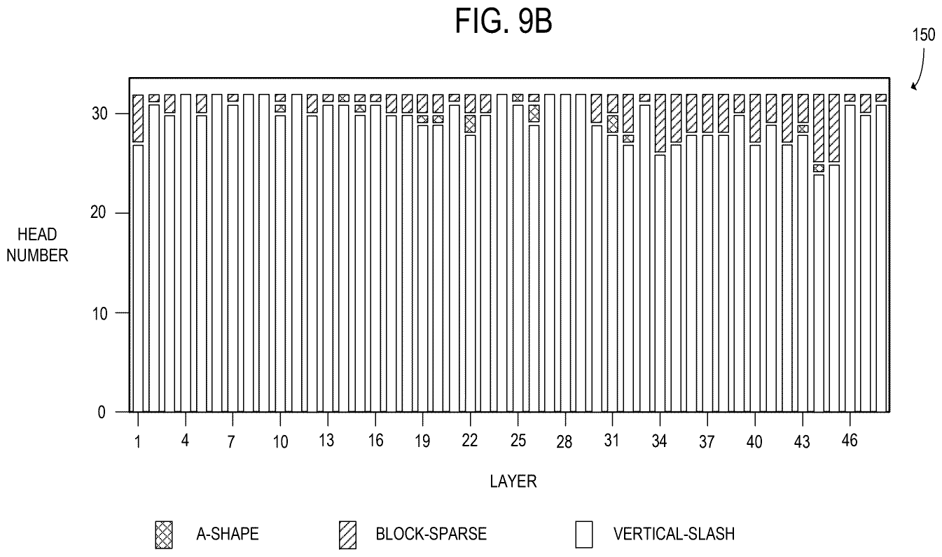

FIGS. 9A-9B show respective plots 140 and 150 of the lowest-error attention head sparsity patterns selected during the calibration stage 56 for LLaMA-3-8B-Instruct-262K and Yi-9B-200K at the different layers of those models. In both models, the majority of the sparsity patterns (>90%) are vertical-slash patterns. However, according to the ablation studies discussed above, using only the vertical-slash pattern significantly impacts performance in highly dynamic tasks like KV retrieval. Secondly, the block-sparse pattern is primarily distributed in several intermediate to later layers, while the A-shape pattern is found in the middle layers. Although the highest-performance patterns vary slightly across different models, they generally align with these observations.

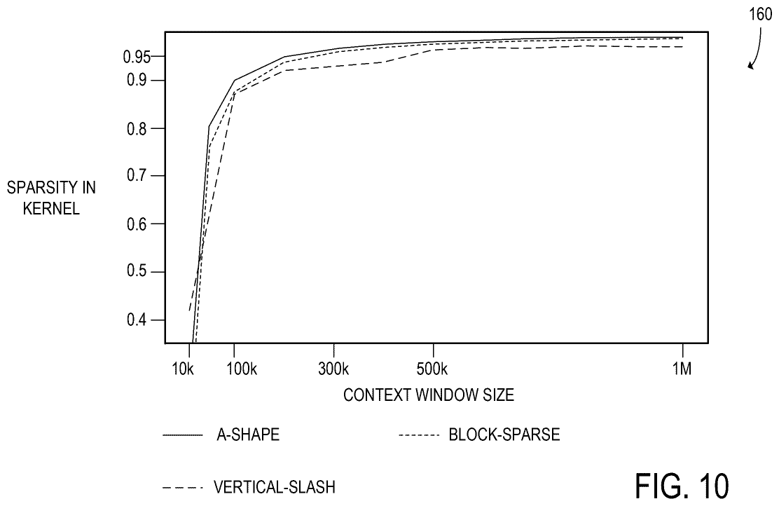

FIG. 10 shows a plot 160 of the sparsity of the attention matrices computed at the GPU kernel with the three different sparsity patterns. This sparsity is shown as a function of the number of tokens in the context window. As shown in FIG. 10, when the context windows exceed 200K tokens, the actual sparsity of all three patterns surpasses 90%. Even considering a 20% index-building overhead, this high sparsity allows the GPU kernel to achieve a speedup of over 8× compared to FlashAttention. Furthermore, when the context windows exceed 500K tokens, the sparsity relative to FlashAttention exceeds 95%, with a theoretical speedup of over 15×.

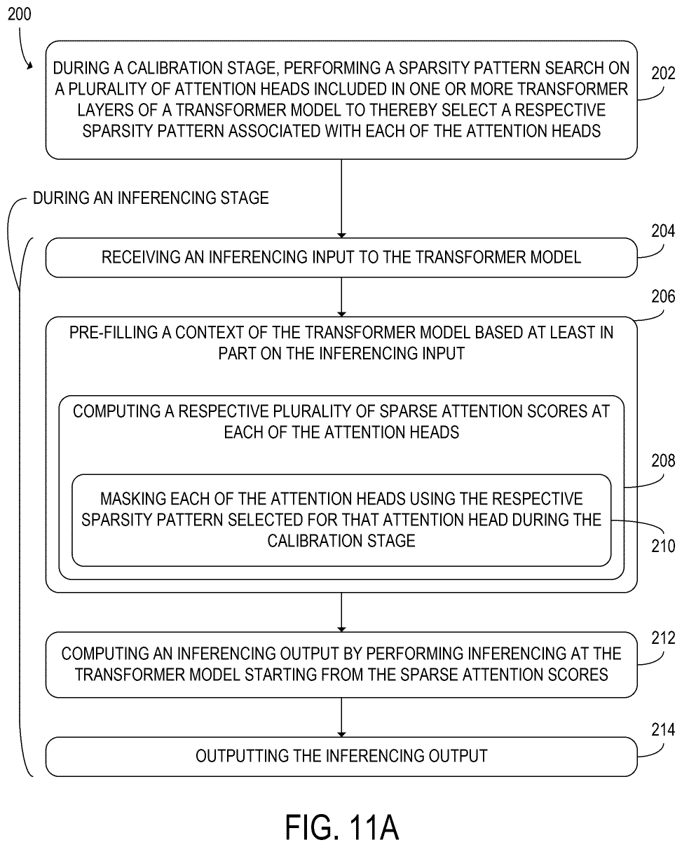

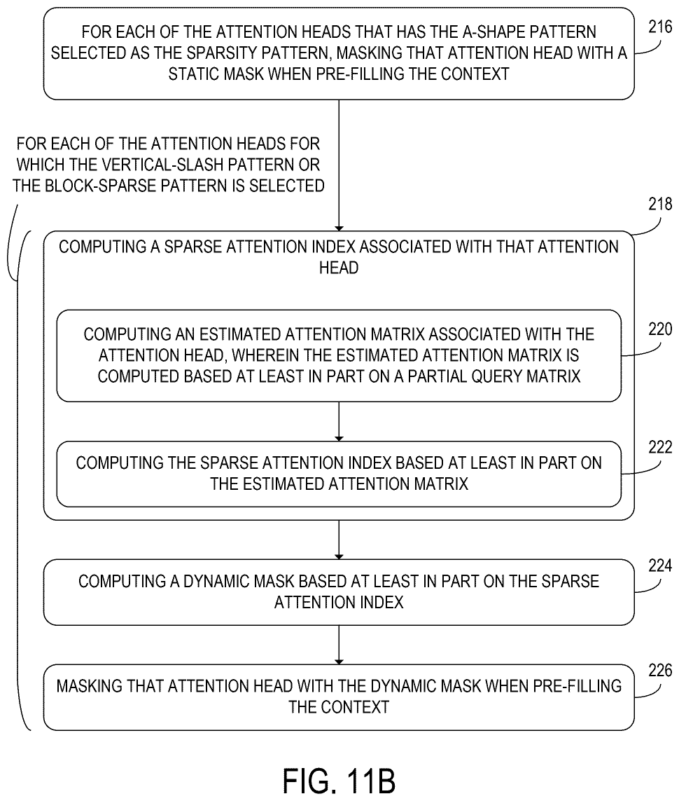

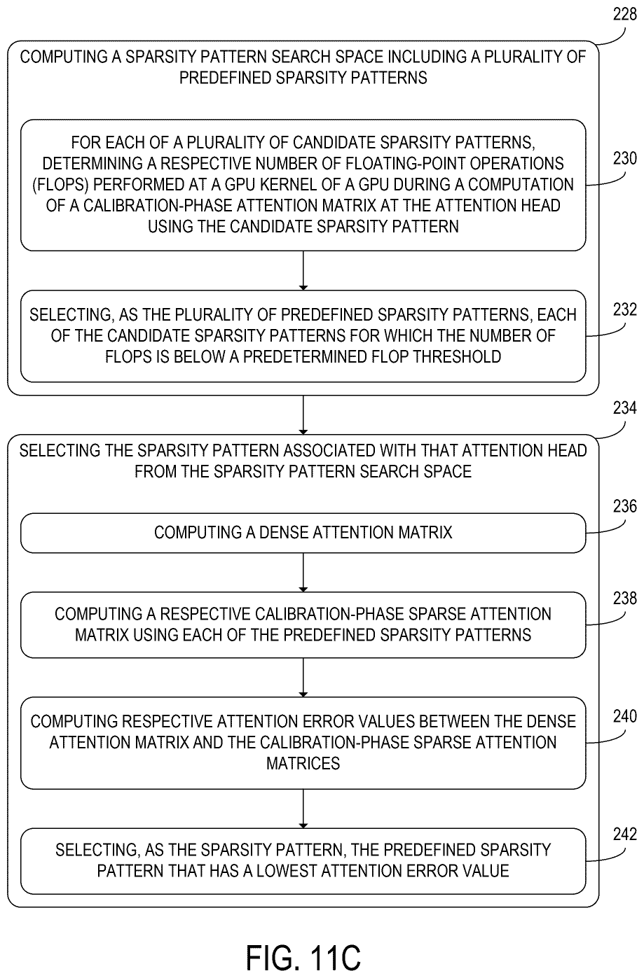

FIG. 11A shows a flowchart of a method 200 for use with a computing system to pre-fill and process a transformer model context. At step 202, during a calibration stage, the method 200 includes performing a sparsity pattern search on a plurality of attention heads included in one or more transformer layers of a transformer model. Thus, at step 202, a respective sparsity pattern associated with each of the attention heads is selected. The plurality of predefined sparsity patterns may include an A-shape pattern, a vertical-slash pattern, and a block-sparse pattern. Each attention head is typically consistent across different inputs as to whether that attention head exhibits the A-shape pattern, the vertical-slash pattern, or the block-sparse pattern, although for the vertical slash pattern and the block-sparse pattern, the locations of the lines and blocks vary between different prompts.

Steps 204, 206, 208, 210, 212, and 214 of the method 200 are performed during an inferencing stage that is performed subsequently to the calibration stage. At step 204, the method 200 includes receiving an inferencing input to the transformer model. The inferencing input includes a plurality of input tokens, which may be text tokens. The inferencing input may, for example, include a large number of tokens, on the order of 10³ to 10⁶ input tokens.

At step 206, the method 200 further includes pre-filling a context of the transformer model based at least in part on the inferencing input. At step 208, pre-filling the context when performing step 206 includes computing a respective plurality of sparse attention scores at each of the attention heads. At step 210, computing the sparse attention scores when performing step 208 includes masking each of the attention heads using the respective sparsity pattern selected for that attention head during the calibration stage. The mask specifies a subset of the attention matrix for which the attention scores are set to zero and are not explicitly computed. Thus, masking the attention heads reduces the amount of computation performed when pre-filling the context.

At step 212, the method 200 further includes computing an inferencing output by performing inferencing at the transformer model starting from the sparse attention scores. For example, the inferencing output may be computed via autoregressive generation of output tokens. At step 214, the method 200 further includes outputting the inferencing output. For example, the inferencing output may be output to a user interface. Thus, the computing system computes and outputs a response to the inferencing input in a manner that is more computationally efficient than using full attention matrices during pre-filling.

FIG. 11B shows additional steps of the method 200 that may be performed during the inferencing stage. At step 216, the method 200 may further include, for each of the attention heads that has the A-shape pattern selected as the sparsity pattern, masking that attention head with a static mask when pre-filling the context. The static mask may mask out the attention scores other than those included in the diagonal of the attention matrix and the first column of the attention matrix.

Steps 218, 220, 222, 224, and 226 may be performed for each of the attention heads for which the vertical-slash pattern or the block-sparse pattern is selected. At step 218, the method 200 may further include computing a sparse attention index associated with that attention head. When that attention head is an attention head for which the vertical-slash pattern was selected during the calibration stage, the sparse attention index may include one or more vertical line indices of one or more respective vertical lines included in the vertical-slash pattern. In addition, the sparse attention index may include one or more slash line indices of one or more respective slash lines included in the vertical-slash pattern. When the attention head is an attention head for which the block-sparse pattern was selected, the sparse attention index may include one or more block indices of one or more respective blocks included in the block-sparse pattern.

At step 220, computing the sparse attention index at step 218 may include computing an estimated attention matrix associated with the attention head. The estimated attention matrix may be computed based at least in part on a partial query matrix that is smaller than the full query matrix. For example, the estimated attention matrix may be computed at least in part by multiplying a last column of a query vector by a key vector (for vertical-slash heads) or performing mean pooling on the query matrix (for block-sparse heads). Mean pooling may also be performed on the key vector when computing the estimated attention matrix for a block-sparse head. At step 222, step 218 may further include computing the sparse attention index based at least in part on the estimated attention matrix. Using the partial query matrix instead of the full query matrix when computing the sparse attention index increases the efficiency of the sparse attention index computation.

At step 224, the method 200 may further include computing a dynamic mask based at least in part on the sparse attention index. The sparse attention index, in such examples, may indicate the regions of the attention matrix that are explicitly computed rather than being masked out. At step 226, the method 200 may further include masking the attention head with the dynamic mask when pre-filling the context. Thus, for vertical-slash and block-sparse attention heads, the attention matrix is masked with a dynamic mask that reflects prompt-specific attention patterns.

FIG. 11C shows additional steps of the method 200 that may be performed for each of the attention heads during the calibration stage. At step 228, the method 200 may further include computing a sparsity pattern search space including a plurality of predefined sparsity patterns. Those predefined sparsity patterns may be the A-shape pattern, the vertical-slash pattern, and the block-sparse pattern. Multiple variants of the vertical-slash pattern and the block-sparse pattern (e.g., with different numbers and/or sizes of lines or blocks) may be included in the sparsity pattern search space in some examples.

In some examples, computing the sparsity pattern search space includes narrowing down a larger search space that includes a plurality of candidate sparsity patterns. At step 230, for each of the candidate sparsity patterns, step 228 may include determining a respective number of FLOPs performed at a GPU kernel of a GPU during a computation of a calibration-phase attention matrix at the attention head using the candidate sparsity pattern. At step 232, step 228 may further include selecting, as the plurality of predefined sparsity patterns, each of the candidate sparsity patterns for which the number of FLOPs is below a predetermined threshold. Thus, the candidate sparsity patterns may be filtered according to their efficiency at the GPU kernel.

At step 234, for each of the attention heads, the method 200 may further include selecting the sparsity pattern associated with that attention head from the sparsity pattern search space. Step 234 may include, at step 236, computing a dense attention matrix. The dense attention matrix may be computed at the transformer model from a calibration-time inferencing input. At step 238, step 234 may further include computing a respective calibration-phase sparse attention matrix using each of the predefined sparsity patterns.

At step 240, step 234 may further include computing respective attention error values between the dense attention matrix and the calibration-phase sparse attention matrices. For example, the attention error values may be L1 error values. The dense attention matrix is accordingly used as a baseline to which the calibration-phase sparse attention matrices are compared. At step 242, step 234 may further include selecting, as the sparsity pattern, the predefined sparsity pattern that has a lowest attention error value. Thus, the computing system may select the predefined sparsity pattern for which the calibration-phase sparse attention matrix is the closest to the dense attention matrix.

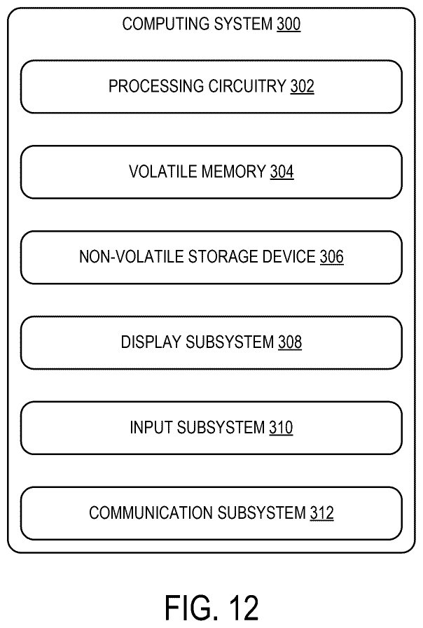

FIG. 12 schematically shows a non-limiting embodiment of a computing system 300 that can enact one or more of the methods and processes described above. Computing system 300 is shown in simplified form. Computing system 300 may embody the computing system described above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including processing circuitry configured to, during a calibration stage, perform a sparsity pattern search on a plurality of attention heads included in one or more transformer layers of a transformer model to thereby select a respective sparsity pattern associated with each of the attention heads. During an inferencing stage, the processing circuitry is further configured to receive an inferencing input to the transformer model. The processing circuitry is further configured to pre-fill a context of the transformer model based at least in part on the inferencing input. Pre-filling the context includes computing a respective plurality of sparse attention scores at each of the attention heads. Computing the sparse attention scores includes masking each of the attention heads using the respective sparsity pattern selected for that attention head during the calibration stage. The processing circuitry is further configured to compute an inferencing output by performing inferencing at the transformer model starting from the sparse attention scores. The processing circuitry is further configured to output the inferencing output. The above features may have the technical effect of pre-filling the context of the transformer model more quickly compared to dense attention computation. The above features may also result in higher inferencing output accuracy.

According to this aspect, the plurality of predefined sparsity patterns may include an A-shape pattern, a vertical-slash pattern, and a block-sparse pattern. The above features may have the technical effect of selecting the sparsity pattern from a set of predefined sparsity patterns that attention heads frequently exhibit.

According to this aspect, for each of the attention heads that has the A-shape pattern selected as the sparsity pattern, the processing circuitry may be further configured to mask that attention head with a static mask when pre-filling the context. The above features may have the technical effect of masking the attention heads that have the A-shape pattern in a static manner, since the A-shape pattern is consistent across different inferencing inputs.

According to this aspect, during the inferencing stage, for each of the attention heads for which the vertical-slash pattern or the block-sparse pattern is selected, the processing circuitry may be further configured to compute a sparse attention index associated with that attention head. The processing circuitry may be further configured to compute a dynamic mask based at least in part on the sparse attention index. The processing circuitry may be further configured to mask that attention head with the dynamic mask when pre-filling the context. The above features may have the technical effect of masking the attention heads with dynamic masks that reflect the attention patterns specific to the inferencing input.

According to this aspect, the processing circuitry may be configured to compute the sparse attention index at least in part by computing an estimated attention matrix associated with the attention head. The estimated attention matrix may be computed based at least in part on a partial query matrix. The sparse attention index may be computed based at least in part on the estimated attention matrix. The above features may have the technical effect of estimating the attention patterns of the attention heads when inferencing is performed on the inferencing input.

According to this aspect, for each of the attention heads for which the vertical-slash pattern is selected, the sparse attention index may include one or more vertical line indices of one or more respective vertical lines included in the vertical-slash pattern. The sparse attention index may further include one or more slash line indices of one or more respective slash lines included in the vertical-slash pattern. The above features may have the technical effect of identifying the portions of the attention weight matrix that are used to compute the sparse attention scores when the vertical-slash pattern is selected.

According to this aspect, for each of the attention heads for which the block-sparse pattern is selected, the sparse attention index may include one or more block indices of one or more respective blocks included in the block-sparse pattern. The above features may have the technical effect of identifying the portions of the attention weight matrix that are used to compute the sparse attention scores when the block-sparse pattern is selected.

According to this aspect, for each of the attention heads, the processing circuitry may be configured to compute a sparsity pattern search space including a plurality of predefined sparsity patterns. The processing circuitry may be further configured to select the sparsity pattern associated with that attention head from the sparsity pattern search space. The above features may have the technical effect of identifying the predefined sparsity patterns by narrowing a larger search space during the calibration stage.

According to this aspect, for each of the attention heads, the processing circuitry may be further configured to compute a dense attention matrix. The processing circuitry may be further configured to compute a respective calibration-phase sparse attention matrix using each of the predefined sparsity patterns. The processing circuitry may be further configured to compute respective attention error values between the dense attention matrix and the calibration-phase sparse attention matrices. The processing circuitry may be further configured to select, as the sparsity pattern, the predefined sparsity pattern that has a lowest attention error value. The above features may have the technical effect of selecting low-error sparsity patterns for the attention heads during the calibration stage.

According to this aspect, the processing circuitry may include a graphics processing unit (GPU) at which the sparse attention scores are computed. For each of the attention heads, the processing circuitry may be configured to compute the sparsity pattern search space at least in part by, for each of a plurality of candidate sparsity patterns, determining a respective number of floating-point operations (FLOPs) performed at a GPU kernel of the GPU during a computation of the calibration-phase sparse attention matrix at the attention head using the candidate sparsity pattern. Computing the sparsity pattern search space may further include selecting, as the plurality of predefined sparsity patterns, each of the candidate sparsity patterns for which the number of FLOPs is below a predetermined FLOP threshold. The above features may have the technical effect of narrowing the sparsity pattern search space to a set of predefined sparsity patterns that have high efficiency in the GPU kernel.

According to another aspect of the present disclosure, a method for use with a computing system is provided. The method includes, during a calibration stage, performing a sparsity pattern search on a plurality of attention heads included in one or more transformer layers of a transformer model to thereby select a respective sparsity pattern associated with each of the attention heads. The method further includes, during an inferencing stage, receiving an inferencing input to the transformer model. The method further includes pre-filling a context of the transformer model based at least in part on the inferencing input. Pre-filling the context includes computing a respective plurality of sparse attention scores at each of the attention heads. Computing the sparse attention scores includes masking each of the attention heads using the respective sparsity pattern selected for that attention head during the calibration stage. The method further includes computing an inferencing output by performing inferencing at the transformer model starting from the sparse attention scores. The method further includes outputting the inferencing output. The above features may have the technical effect of pre-filling the context of the transformer model more quickly compared to dense attention computation. The above features may also result in higher inferencing output accuracy.

According to this aspect, the plurality of predefined sparsity patterns may include an A-shape pattern, a vertical-slash pattern, and a block-sparse pattern. The above features may have the technical effect of selecting the sparsity pattern from a set of predefined sparsity patterns that attention heads frequently exhibit.

According to this aspect, for each of the attention heads that has the A-shape pattern selected as the sparsity pattern, the method may further include masking that attention head with a static mask when pre-filling the context. The above features may have the technical effect of masking the attention heads that have the A-shape pattern in a static manner, since the A-shape pattern is consistent across different inferencing inputs.

According to this aspect, during the inferencing stage, for each of the attention heads for which the vertical-slash pattern or the block-sparse pattern is selected, the method may further include computing a sparse attention index associated with that attention head. The method may further include computing a dynamic mask based at least in part on the sparse attention index. The method may further include masking that attention head with the dynamic mask when pre-filling the context. The above features may have the technical effect of masking the attention heads with dynamic masks that reflect the attention patterns specific to the inferencing input.

According to this aspect, computing the sparse attention index may include computing an estimated attention matrix associated with the attention head. The estimated attention matrix may be computed based at least in part on a partial query matrix. The method may further include computing the sparse attention index based at least in part on the estimated attention matrix. The above features may have the technical effect of estimating the attention patterns of the attention heads when inferencing is performed on the inferencing input.

According to this aspect, for each of the attention heads for which the vertical-slash pattern is selected, the sparse attention index may include one or more vertical line indices of one or more respective vertical lines included in the vertical-slash pattern. The sparse attention index may further include one or more slash line indices of one or more respective slash lines included in the vertical-slash pattern. The above features may have the technical effect of identifying the portions of the attention weight matrix that are used to compute the sparse attention scores when the vertical-slash pattern is selected.

According to this aspect, for each of the attention heads for which the block-sparse pattern is selected, the sparse attention index may include one or more block indices of one or more respective blocks included in the block-sparse pattern. The above features may have the technical effect of identifying the portions of the attention weight matrix that are used to compute the sparse attention scores when the block-sparse pattern is selected.

According to this aspect, for each of the attention heads, the method may further include computing a sparsity pattern search space including a plurality of predefined sparsity patterns. The method may further include selecting the sparsity pattern associated with that attention head from the sparsity pattern search space. The above features may have the technical effect of identifying the predefined sparsity patterns by narrowing a larger search space during the calibration stage.

According to this aspect, for each of the attention heads, the method may further include computing a dense attention matrix. The method may further include computing a respective calibration-phase sparse attention matrix using each of the predefined sparsity patterns. The method may further include computing respective attention error values between the dense attention matrix and the calibration-phase sparse attention matrices. The method may further include selecting, as the sparsity pattern, the predefined sparsity pattern that has a lowest attention error value. The above features may have the technical effect of selecting low-error sparsity patterns for the attention heads during the calibration stage.

According to another aspect of the present disclosure, a computing system is provided, including processing circuitry configured to, during a calibration stage, perform a sparsity pattern search on a plurality of attention heads included in one or more transformer layers of a transformer model to thereby select a respective sparsity pattern associated with each of the attention heads. The plurality of predefined sparsity patterns include an A-shape pattern, a vertical-slash pattern, and a block-sparse pattern. During an inferencing stage, the processing circuitry is further configured to receive an inferencing input to the transformer model. The processing circuitry is further configured to process the inferencing input at the transformer model to compute an inferencing output. Computing the inferencing output includes computing a respective plurality of sparse attention scores at each of the attention heads. Computing the sparse attention scores includes masking each of the attention heads using the respective sparsity pattern selected for that attention head during the calibration stage. The processing circuitry is further configured to output the inferencing output. The above features may have the technical effect of pre-filling the context of the transformer model more quickly compared to dense attention computation. The above features may also result in higher inferencing output accuracy.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
processing circuitry configured to:
during a calibration stage, perform a sparsity pattern search on a plurality of attention heads included in one or more transformer layers of a transformer model to thereby select a respective sparsity pattern associated with each of the attention heads; and
during an inferencing stage:
receive an inferencing input to the transformer model;
pre-fill a context of the transformer model based at least in part on the inferencing input, wherein:
pre-filling the context includes computing a respective plurality of sparse attention scores at each of the attention heads; and
computing the sparse attention scores includes masking each of the attention heads using the respective sparsity pattern selected for that attention head during the calibration stage;
compute an inferencing output by performing inferencing at the transformer model starting from the sparse attention scores; and
output the inferencing output.

2. The computing system of claim 1, wherein the plurality of predefined sparsity patterns include an A-shape pattern, a vertical-slash pattern, and a block-sparse pattern.

3. The computing system of claim 2, wherein, for each of the attention heads that has the A-shape pattern selected as the sparsity pattern, the processing circuitry is further configured to mask that attention head with a static mask when pre-filling the context.

4. The computing system of claim 2, wherein, during the inferencing stage, for each of the attention heads for which the vertical-slash pattern or the block-sparse pattern is selected, the processing circuitry is further configured to:
compute a sparse attention index associated with that attention head;
compute a dynamic mask based at least in part on the sparse attention index; and
mask that attention head with the dynamic mask when pre-filling the context.

5. The computing system of claim 4, wherein the processing circuitry is configured to compute the sparse attention index at least in part by:
computing an estimated attention matrix associated with the attention head, wherein the estimated attention matrix is computed based at least in part on a partial query matrix; and
computing the sparse attention index based at least in part on the estimated attention matrix.

6. The computing system of claim 4, wherein, for each of the attention heads for which the vertical-slash pattern is selected, the sparse attention index includes:
one or more vertical line indices of one or more respective vertical lines included in the vertical-slash pattern; and
one or more slash line indices of one or more respective slash lines included in the vertical-slash pattern.

7. The computing system of claim 4, wherein, for each of the attention heads for which the block-sparse pattern is selected, the sparse attention index includes one or more block indices of one or more respective blocks included in the block-sparse pattern.

8. The computing system of claim 1, wherein, for each of the attention heads, the processing circuitry is configured to:
compute a sparsity pattern search space including a plurality of predefined sparsity patterns; and
select the sparsity pattern associated with that attention head from the sparsity pattern search space.

9. The computing system of claim 8, wherein, for each of the attention heads, the processing circuitry is further configured to:
compute a dense attention matrix;
compute a respective calibration-phase sparse attention matrix using each of the predefined sparsity patterns;
compute respective attention error values between the dense attention matrix and the calibration-phase sparse attention matrices; and
select, as the sparsity pattern, the predefined sparsity pattern that has a lowest attention error value.

10. The computing system of claim 8, wherein:
the processing circuitry includes a graphics processing unit (GPU) at which the sparse attention scores are computed; and
for each of the attention heads, the processing circuitry is configured to compute the sparsity pattern search space at least in part by:
for each of a plurality of candidate sparsity patterns, determining a respective number of floating-point operations (FLOPs) performed at a GPU kernel of the GPU during a computation of the calibration-phase sparse attention matrix at the attention head using the candidate sparsity pattern; and
selecting, as the plurality of predefined sparsity patterns, each of the candidate sparsity patterns for which the number of FLOPs is below a predetermined FLOP threshold.

11. A method for use with a computing system, the method comprising:
during a calibration stage, performing a sparsity pattern search on a plurality of attention heads included in one or more transformer layers of a transformer model to thereby select a respective sparsity pattern associated with each of the attention heads; and
during an inferencing stage:
receiving an inferencing input to the transformer model;
pre-filling a context of the transformer model based at least in part on the inferencing input, wherein:
pre-filling the context includes computing a respective plurality of sparse attention scores at each of the attention heads; and
computing the sparse attention scores includes masking each of the attention heads using the respective sparsity pattern selected for that attention head during the calibration stage;
computing an inferencing output by performing inferencing at the transformer model starting from the sparse attention scores; and
outputting the inferencing output.

12. The method of claim 11, wherein the plurality of predefined sparsity patterns include an A-shape pattern, a vertical-slash pattern, and a block-sparse pattern.

13. The method of claim 12, further comprising, for each of the attention heads that has the A-shape pattern selected as the sparsity pattern, masking that attention head with a static mask when pre-filling the context.

14. The method of claim 12, further comprising, during the inferencing stage, for each of the attention heads for which the vertical-slash pattern or the block-sparse pattern is selected:
computing a sparse attention index associated with that attention head;
computing a dynamic mask based at least in part on the sparse attention index; and
masking that attention head with the dynamic mask when pre-filling the context.

15. The method of claim 14, wherein computing the sparse attention index includes:
computing an estimated attention matrix associated with the attention head, wherein the estimated attention matrix is computed based at least in part on a partial query matrix; and
computing the sparse attention index based at least in part on the estimated attention matrix.

16. The method of claim 14, wherein, for each of the attention heads for which the vertical-slash pattern is selected, the sparse attention index includes:
one or more vertical line indices of one or more respective vertical lines included in the vertical-slash pattern; and
one or more slash line indices of one or more respective slash lines included in the vertical-slash pattern.

17. The method of claim 14, wherein, for each of the attention heads for which the block-sparse pattern is selected, the sparse attention index includes one or more block indices of one or more respective blocks included in the block-sparse pattern.

18. The method of claim 11, further comprising, for each of the attention heads:
computing a sparsity pattern search space including a plurality of predefined sparsity patterns; and
selecting the sparsity pattern associated with that attention head from the sparsity pattern search space.

19. The method of claim 18, wherein, for each of the attention heads, the method further comprises:
computing a dense attention matrix;
computing a respective calibration-phase sparse attention matrix using each of the predefined sparsity patterns;
computing respective attention error values between the dense attention matrix and the calibration-phase sparse attention matrices; and
selecting, as the sparsity pattern, the predefined sparsity pattern that has a lowest attention error value.

20. A computing system comprising:
processing circuitry configured to:
during a calibration stage, perform a sparsity pattern search on a plurality of attention heads included in one or more transformer layers of a transformer model to thereby select a respective sparsity pattern associated with each of the attention heads, wherein the plurality of predefined sparsity patterns include an A-shape pattern, a vertical-slash pattern, and a block-sparse pattern; and
during an inferencing stage:
receive an inferencing input to the transformer model;
process the inferencing input at the transformer model to compute an inferencing output, wherein:
computing the inferencing output includes computing a respective plurality of sparse attention scores at each of the attention heads; and
computing the sparse attention scores includes masking each of the attention heads using the respective sparsity pattern selected for that attention head during the calibration stage; and
output the inferencing output.
